(19) United States
(12) Patent Application Publication
(10) Pub. No.: US 2020/0226902 A1
(43) Pub. Date: Jul. 16, 2020

(54) MULTIPURPOSE EVENT DETECTION SENSOR AND PAYLOAD ALERT SYSTEM

(71) Applicant: BMMPR, San Marcos, CA (US)

(72) Inventors: Marko Mandaric, San Marcos, CA (US); Heath Clement Oyama, Vista, CA (US)

(21) Appl. No.: 16/807,073

(22) Filed: Mar. 2, 2020

Related U.S. Application Data
(63) Continuation-in-part of application No. 16/133,518, filed on Sep. 17, 2018, now Pat. No. 10,580,278.
Application No. 16/133,518 is a continuation of application No. 15/842,612, filed on Dec. 14, 2017, now Pat. No. 10,115,281.
Application No. 15/842,612 is a continuation of application No. PCT/US2016/068292, filed on Dec. 22, 2016.
(60) Provisional application No. 62/429,380, filed on Dec. 2, 2016.
(60) Provisional application No. 62/246,004, filed on Dec. 30, 2015.

(51) Int. Cl. G08B 19/00; G08B 25/08; G06F 9/44; G06F 9/445; G08B 21/18; G08B 25/10

(52) U.S. Cl. CPC G08B 19/00; G08B 25/08; G06F 9/44; B60R 25/102; G08B 21/182; G08B 25/10; G06F 9/445

(57) ABSTRACT

Embodiments of the present invention are generally directed towards providing a multipurpose event detection sensor and a communications means for delivering a payload notification. In particular, embodiments of the present invention are configured to provide a system comprising a sensor capable of detecting events, such as vibrations of varying forms and amplitude, generating an alert based on certain parameters of those events and transmitting that alert to a remote system via a communications means.

### CROSS-REFERENCE TO RELATED APPLICATIONS

This application is a Continuation-in-part of U.S. Non-provisional application Ser. No. 16/133,518, filed on Sep. 17, 2018, which is a continuation of U.S. Non-provisional application Ser. No. 15/842,612 filed on Dec. 14, 2017 which is a continuation of PCT International Application No. PCT/US2016/068292, filed on Dec. 22, 2016, and published in English on Jul. 6, 2017 as WO 2017/116980, which claims benefit of priority to U.S. Provisional Application 62/429,380, filed on Dec. 2, 2016, and which also claims benefit of priority to U.S. Provisional Application 62/246,004, filed on Dec. 30, 2015, each of which are hereby expressly incorporated herein by reference in their entirety.

### FIELD OF THE INVENTION

Embodiments of the present invention are generally directed towards providing a multipurpose event detection sensor and a communications means for delivering a payload notification. In particular, embodiments of the present invention are configured to provide a system comprising a sensor capable of detecting events, such as vibrations of varying forms and amplitude, generating an alert based on certain parameters of those events and transmitting that alert to a remote system via a communications means.

### BACKGROUND

Typical modern automotive alarm systems (those installed as original equipment, and those installed “aftermarket”) are capable of detecting events that require attention. These configurations however fall short in additionally notifying remote devices by wireless means in response to those events. Accordingly a sensor allowing the ability to contact a remote device as a response to an event, is desirable.

Further, most modern automotive alarm systems are simple in nature and are unable to provide detailed information with respect to an event. For instance, a glass break sensor may be able to tell that a loud noise occurred (e.g., window breaking), but not identify which window was shattered. In further examples, impact sensors may detect an impact with enough force to set off the alarm, but provide no further information about where the impact occurred, the strength of the actual impact, what directional force was applied to the vehicle or any other information about the impact or result.

In many situations, it would be desirable for an automotive alarm system, or similar sensor driven alert system, to be able to provide granular detail about events detected by sensors associated with the automotive alarm system, and then transmit that information to relevant sources for further processing and handling of the events.

Therefore, there is need in the art for systems and methods for providing a multipurpose event detection sensor and a communications means for delivering a payload notification. These and other features and advantages of the present invention will be explained and will become obvious to one skilled in the art through the summary of the invention that follows.

### SUMMARY OF THE INVENTION

Accordingly, it is an aspect of the present invention to provide systems and methods for providing a multipurpose event detection sensor and a communications means for delivering a payload notification.

According to an embodiment of the present invention, an event detecting sensor and alert system comprises: one or more event sensors, each event sensor comprising circuitry for detecting an event; a processor; and one or more communications means, wherein said one or more event sensors, said processor and said one or more communications means are operably connected and are configured to: detect, via said one or more event sensors, event data associated with an event; analyze said event data to determine if said event data exceeds a given threshold; generate an event message payload, where said event data exceeded said given threshold, and wherein said event message payload comprises relevant information about said event; and transmit, via said communications means, said event message payload to a remote processing system.

According to an embodiment of the present invention, the one or more event sensors, said processor and said one or more communications means are further configured to: identify an event type from said event data; generate specific alert information for said event message payload, based at least in part on said event type.

According to an embodiment of the present invention, at least one of said one or more event sensors are selected from the group comprising an accelerometer, a microphone, a hall effect sensor, and a temperature sensor.

According to an embodiment of the present invention, the event data comprises identification of vibrations of varying forms and amplitudes.

According to an embodiment of the present invention, the system further comprises: a remote processing system, comprising a remote processor, a remote communications means and a payload processing module stored in non-transitory memory and configured to instruct the remote processor to: identify an event provider associated with said event message payload; process said event message payload for event specific information; generate an end user message based at least in part on said event specific information; identify one or more end user recipients for said end user message; and transmit said end user message to said one or more end user recipients

According to an embodiment of the present invention, the event specific information comprises information about a severity of said event.

According to an embodiment of the present invention, the event specific information comprises information about a type of said event.

According to an embodiment of the present invention, a method for providing an event detecting sensor and alert system comprises the steps of: detecting, via one or more event sensors, event data associated with an event; analyzing said event data to determine if said event data exceeds a given threshold; generating an event message payload, where said event data exceeded said given threshold, and wherein said event message payload comprises relevant information about said event; and transmitting, via a communications means, said event message payload to a remote processing system.

According to an embodiment of the present invention, the method further comprises the steps of: identifying an event type from said event data; generating specific alert information for said event message payload, based at least in part on said event type.

According to an embodiment of the present invention, the method further comprises the steps of: identifying an event provider associated with said event message payload; processing said event message payload for event specific information; generating an end user message based at least in part on said event specific information; identifying one or more end user recipients for said end user message; and transmitting said end user message to said one or more end user recipients.

According to an embodiment of the present invention, an event detecting sensor and alert system comprises: a power bus; one or more processor, operably connected to the power bus to receive from the power bus electrical power and a sensor data signal; one or more sensor, operably connected to the power bus to receive from the power bus electrical power and send a data signal through the power bus; and, a memory, operably coupled with the one or more processor, the memory encoding data and processor executable program instructions, that when executed by the one or more processor, cause the one or more processor to perform operations comprising: receive from the power bus a data signal sent by the sensor through the power bus; detect the occurrence of an event determined as a function of the received data signal; and, send to a remote processing system an event message payload generated as a function of the detected event.

According to an embodiment of the present invention, the event detecting sensor and alert system further comprises an accelerometer.

According to an embodiment of the present invention, the event detecting sensor and alert system further comprises a barometer.

According to an embodiment of the present invention, the event detecting sensor and alert system further comprises an altimeter.

According to an embodiment of the present invention, the event detecting sensor and alert system further comprises at least one microphone.

According to an embodiment of the present invention, the event detecting sensor and alert system further comprises at least one motion sensor.

According to an embodiment of the present invention, the event detecting sensor and alert system further comprises a camera.

According to an embodiment of the present invention, the one or more sensor further comprises a capacitive touch sensor.

According to an embodiment of the present invention, the capacitive touch sensor is operably connected to the power bus to receive electrical power and send a sensor data signal through the power bus.

According to an embodiment of the present invention, the camera is operably connected to the power bus.

According to an embodiment of the present invention, the event detecting sensor and alert system is operably connected to the camera by a harness retaining the event detecting sensor and alert system.

According to an embodiment of the present invention, the power bus further comprises a vehicle power bus.

According to an embodiment of the present invention, the data signal sent through the power bus further comprises a message start phase, a message content phase, and a message end phase.

According to an embodiment of the present invention, the operations performed by the one or more processor further comprise determining a valid message has been received through the power bus when the message start phase, the message content phase, and the message end phase have been received without error by the processor.

According to an embodiment of the present invention, the data signal sent through the power bus further comprises a signal voltage superimposed with the power bus supply voltage.

According to an embodiment of the present invention, data are encoded with the signal voltage sent through the power bus based on varying the signal voltage.

According to an embodiment of the present invention, the event detecting sensor and alert system is installed in a vehicle.

According to an embodiment of the present invention, the event detecting sensor and alert system is installed in a data center.

According to an embodiment of the present invention, the operations performed by the one or more processor further comprise: detect the occurrence of a touch event sensed by a capacitive touch sensor, wherein the touch event occurrence is determined as a function of a sensor data signal received from the capacitive touch sensor through the power bus.

According to an embodiment of the present invention, the operations performed by the one or more processor further comprise: determine, based on the touch event sensed by the capacitive touch sensor, the location touched; and, activate the camera to capture an image from the location touched.

According to an embodiment of the present invention, the event detecting sensor and alert system further comprises a head unit configured to govern the operations performed by the system and communicate with a remote processing system.

According to an embodiment of the present invention, the operations performed by the one or more processor further comprise: in response to determining the event detecting sensor and alert system is unable to communicate via the power bus with one or more sensor, send a panic message to the head unit via an Ethernet interface configured as backup communication means.

According to an embodiment of the present invention, the event detecting sensor and alert system further comprises a sensor and alert system connector configured to operably connect the event detecting sensor and alert system to a vehicle diagnostic port.

According to an embodiment of the present invention, the event detecting sensor and alert system further comprises a printed circuit board operably retaining the accelerometer.

According to an embodiment of the present invention, the event detecting sensor and alert system further comprises a right angle adapter configured to connect the vehicle diagnostic port to the printed circuit board operably retaining the accelerometer, wherein the printed circuit board includes a connector operably coupled with the right angle adapter, and wherein the printed circuit board is not in physical contact with the diagnostic port.

According to an embodiment of the present invention, the event detecting sensor and alert system printed circuit board further comprises a main printed circuit board, and a daughter printed circuit board removably and operably attached to the main printed circuit board.

According to an embodiment of the present invention, the event detecting sensor and alert system further comprises printed circuit board connector pins formed in a right angle, with the longitudinal dimension of the connector pins joined to the circuit board disposed substantially perpendicular to the plane of the main printed circuit board major surface.

According to an embodiment of the present invention, the event detecting sensor and alert system further comprises the event detecting sensor and alert system installed in a vehicle diagnostic port, wherein the plane of the event detecting sensor and alert system main printed circuit board major surface is disposed substantially perpendicular to a plane tangential to each vehicle wheel at the point on each wheel at which, if the vehicle were resting on the vehicle's wheels on a flat surface, that point on each wheel would contact the flat surface on which the vehicle could rest.

According to an embodiment of the present invention, the event detecting sensor and alert system further comprises the center of the integrated circuit retaining the accelerometer disposed at least one centimeter from the printed circuit board connector pins closest to the right angle adapter.

According to an embodiment of the present invention, the event detecting sensor and alert system further comprises the center of the integrated circuit retaining the accelerometer disposed at least two centimeters from the printed circuit board connector pins closest to the right angle adapter.

According to an embodiment of the present invention, the event detecting sensor and alert system further comprises the center of the integrated circuit retaining the accelerometer disposed at least three centimeters from the printed circuit board connector pins closest to the right angle adapter.

According to an embodiment of the present invention, the event detecting sensor and alert system further comprises the accelerometer disposed substantially parallel to the plane of the printed circuit board major dimension.

According to an embodiment of the present invention, an event detecting sensor and alert system comprises: one or more processor; one or more sensor, operably connected to the one or more processor; and, a memory, operably coupled with the one or more processor, the memory encoding data and processor executable program instructions, that when executed by the one or more processor, cause the one or more processor to perform operations comprising: receive sensor data from the sensor; detect the occurrence of an event determined as a function of the sensor data; and, send to a remote processing system an event message payload generated as a function of the detected event.

According to an embodiment of the present invention, the one or more sensor further comprises an accelerometer.

According to an embodiment of the present invention, the event detecting sensor and alert system is installed in a vehicle.

According to an embodiment of the present invention, the operations performed by the one or more processor further comprise calculating the direction of an impact to the vehicle determined as a function of accelerometer sensor data.

According to an embodiment of the present invention, the operations performed by the one or more processor further comprise calculating the location of the impact to the vehicle determined as a function of the impact direction.

According to an embodiment of the present invention, the operations performed by the one or more processor further comprise: in response to detecting an impact to the vehicle, capture from the accelerometer a plurality samples of the vibration resulting from the impact.

According to an embodiment of the present invention, the operations performed by the one or more processor further comprise: determining the location of the impact based on a phase shift measured between at least two of the plurality of samples of the vibration resulting from the impact.

According to an embodiment of the present invention, the operations performed by the one or more processor further comprise: determining the location of the impact based on an amplitude shift measured between at least two of the plurality of samples of the vibration resulting from the impact.

According to an embodiment of the present invention, the operations performed by the one or more processor further comprise: determining at least one of the plurality of vibration samples is an echo, based on determining a decrease in vibration amplitude between at least two of the plurality of vibration samples.

According to an embodiment of the present invention, the operations performed by the one or more processor further comprise: determining the location of an impact to the vehicle based at least in part on at least one vibration sample that is not an echo.

According to an embodiment of the present invention, the operations performed by the one or more processor further comprise: identifying the impact type, determined as a function of a composite sample constructed by summing at least two of the plurality of samples of the vibration resulting from the impact, and dividing the sum by the number of samples summed.

According to an embodiment of the present invention, an event detecting sensor and alert system further comprises more than one accelerometer, and the operations performed by the one or more processor further comprise fusing the data from the more than one accelerometer to determine the direction of an impact to the vehicle based on comparing the times the vibration resulting from the impact is detected by each of the more than one accelerometer.

According to an embodiment of the present invention, the one or more sensor further comprises a barometric pressure sensor configured in a vehicle interior, and the operations performed by the one or more processor further comprise: determining a reference barometric pressure, based on barometric pressure data received from the barometric pressure sensor; monitor the barometric pressure in the vehicle interior, based on sampling barometric pressure data received from the barometric pressure sensor; in response to determining the monitored barometric pressure is lower than the reference barometric pressure by at least a predetermined margin, determine if the monitored barometric pressure is restored to the reference barometric pressure within a predetermined minimum period of time; in response to determining the monitored barometric pressure is restored to the reference barometric pressure within the predetermined minimum period of time, identify the event as a window puncture event; and, send to the remote processing system an event message payload generated as a function of the detected window puncture.

According to an embodiment of the present invention, the event detecting sensor and alert system further comprises an accelerometer, and the operations performed by the one or more processor further comprise detecting, based on accelerometer data, an impact to the vehicle; determining if the detected impact occurred within a predetermined minimum period of time relative to the time the monitored barometric pressure is restored to the reference barometric pressure; and, in response to determining the detected impact occurred within the predetermined minimum period of time relative to the time the monitored barometric pressure was restored to the reference barometric pressure, identify the event as a window puncture event; and, send to the remote processing system an event message payload generated as a function of the detected window puncture.

According to an embodiment of the present invention, an event detecting sensor and alert system comprises: one or more processor; an accelerometer, operably connected to the one or more processor; a communication interface, operable to communicatively couple the processor with the TPMS (Tire Pressure Monitoring System) of a vehicle; and, a memory, operably coupled with the one or more processor, the memory encoding data and processor executable program instructions, that when executed by the one or more processor, cause the one or more processor to perform operations comprising: receive sensor data from the accelerometer; determine if vibration is detected directed substantially from the location of at least one vehicle tire, based on the accelerometer data; in response to determining vibration substantially directed from the location of at least one vehicle tire is detected, query the vehicle TPMS, to determine if the pressure in the tire from which vibration was detected has dropped at least a predetermined minimum pressure margin, and identify the detected event as a tire slash event; and, send to a remote processing system an event message payload generated as a function of the detected tire slash event.

According to an embodiment of the present invention, the operations performed by the one or more processor further comprise determining a reference acceleration due to gravity measured based on the accelerometer data; in response to determining vibration substantially directed from the location of at least one vehicle tire is detected, monitoring the acceleration due to gravity measured based on the accelerometer data, to determine if the altitude of at least one vehicle frame corner has decreased, determined as a comparison function of the reference acceleration due to gravity and the monitored acceleration due to gravity; and, in response to determining the altitude of at least one vehicle frame corner has decreased, identify the detected event as a tire slash event, and send to a remote processing system an event message payload generated as a function of the detected tire slash event.

According to an embodiment of the present invention, an event detecting sensor and alert system configured to detect an event related to a vehicle comprises: one or more processor; two or more motion sensors, operably connected to the one or more processor; a camera mounted within the vehicle interior, the camera operably connected to the processor to pan, tilt, and zoom as directed by the processor; a plurality of lights disposed around the perimeter of the vehicle exterior, the plurality of lights operably connected to the processor; and, a memory, operably coupled with the one or more processor, the memory encoding data and processor executable program instructions, that when executed by the one or more processor, cause the one or more processor to perform operations comprising: receive sensor data from the two or more motion sensors; determine if a human is walking near the vehicle detected as a function of the data from the two or more motion sensors; in response to determining a human is walking near the vehicle, illuminate vehicle exterior lights in an illumination pattern determined as a function of the human location determined based on the sensor data from the two or more motion sensors; activate the camera to capture an image from the human location; and, send to a remote processing system an event message payload generated as a function of the detected human walking near the vehicle, wherein the message payload includes the image.

According to an embodiment of the present invention, the two or more motion sensors are passive IR (infra-red) motion sensors.

According to an embodiment of the present invention, the operations performed by the one or more processor further comprise the illumination pattern following the human as the human walks around the vehicle.

According to an embodiment of the present invention, the operations performed by the one or more processor further comprise: determine if the human is a threat to the vehicle, based on determining if the human remains within a predetermined minimum distance from the vehicle for at least a predetermined minimum time period; and, in response to determining the human is a threat to the vehicle, send to a remote processing system an event message payload generated as a function of the detected human walking near the vehicle, wherein the message payload includes the image.

According to an embodiment of the present invention, the operations performed by the one or more processor further comprise: in response to detecting the location of an object in motion determined as a function of the two or more motion sensors, determine if the motion detected is in the field of view of a vehicle window; in response to determining the motion detected is in the field of view of a vehicle window, direct the camera to measure the light volume through the window; compare the light volume through the window measured by the camera to a predetermined reference light volume, to determine if light volume is blocked by an object near the window, based on the comparison; and, in response to determining light volume is blocked, initiate a response.

According to an embodiment of the present invention, the operations performed by the one or more processor further comprise determining a degree of threat to the vehicle based on the light volume blocked by the object and the length of time the light is blocked; and, escalating the response severity based on the degree of threat.

According to an embodiment of the present invention, the response further comprises a response selected from the group flash exterior lights, sound the vehicle horn, and send to a remote processing system an event message payload generated as a function of the object detected near the vehicle.

According to an embodiment of the present invention, an event detecting sensor and alert system comprises: one or more processor; one or more strain gauge sensor configured in a lug nut to measure the torque applied by the lug nut to a wheel mounting stud to which the lug nut may be installed, the one or more strain gauge sensor operably connected to the one or more processor; and, a memory, operably coupled with the one or more processor, the memory encoding data and processor executable program instructions, that when executed by the one or more processor, cause the one or more processor to perform operations comprising: receive strain gauge measurement data from the one or more strain gauge sensor; detect the occurrence of a lug nut installation event determined as a function of the strain gauge measurement data; in response to detecting the lug nut installation event, detect the occurrence of a lug nut loosening event determined as a function of the strain gauge measurement data; and, send to a remote processing system an event message payload generated as a function of the detected lug nut loosening event.

According to an embodiment of the present invention, the operations performed by the one or more processor further comprise in response to determining the torque applied by the lug nut is greater than or equal to a predetermined nominal torque, go to sleep, comprising: activate a standby mode in the lug nut, and configuring the lug nut in a low power mode; in response to determining the torque applied by the lug nut is less than a predetermined minimum torque, activate an operational mode in the lug nut, and, send to the remote processing system a panic event message payload generated as a function of the detected lug nut loosening event.

According to an embodiment of the present invention, an event detecting sensor and alert system installed in each vehicle of a plurality of vehicles comprises: one or more processor; one or more accelerometer, operably connected to the one or more processor; a wireless mesh network interface operably connected to the one or more processor to govern communication with each other vehicle of the plurality of vehicles; and, a memory, operably coupled with the one or more processor, the memory encoding data and processor executable program instructions, that when executed by the one or more processor, cause the one or more processor to perform operations comprising: receive sensor data from the accelerometer; detect the occurrence of an event determined as a function of the sensor data; and, send to another vehicle of the plurality of vehicles an event message payload generated as a function of the detected event.

According to an embodiment of the present invention, the wireless mesh network further comprises a multi-accessory sub-gigahertz wireless mesh network.

According to an embodiment of the present invention, the operations performed by the one or more processor further comprise detect for one vehicle hard braking determined as a function of sensor data from the accelerometer located in the hard braking vehicle; in response to detecting hard braking by the braking vehicle, send, by the braking vehicle to another vehicle of the plurality of vehicles driving behind the braking vehicle telemetry indicating hard braking by a vehicle ahead; receiving, by the another vehicle of the plurality of vehicles driving behind the braking vehicle, the telemetry; and, in response to the telemetry received by the another vehicle of the plurality of vehicles driving behind the braking vehicle, slowing down the vehicle driving behind the braking vehicle.

According to an embodiment of the present invention, the event detecting sensor and alert system installed in each vehicle of a plurality of vehicles further comprises a distance of at least four miles between the braking vehicle and the vehicle driving behind the braking vehicle.

According to an embodiment of the present invention, the event detecting sensor and alert system in each vehicle of a plurality of vehicles further comprises machine learning and artificial intelligence trained to recognize normal and anomalous traffic patterns determined as functions of historical sensor data characterizing traffic scenario outcomes identified based on mathematical and statistical models, and the operations performed by the one or more processor further comprise: determining if a traffic pattern determined for at least one vehicle is statistically consistent with normal traffic; and, in response to determining the traffic pattern is not consistent with normal traffic, sending telemetry to other vehicles behind the at least one vehicle, wherein the telemetry indicates the other vehicles should increase following distance.

According to an embodiment of the present invention, the event detecting sensor and alert system in each vehicle of a plurality of vehicles further comprises a computer vision system operably coupled with the one or more processor, and the operations performed by the one or more processor further comprise: in response to determining an adverse event for a first vehicle based on accelerometer data from the first vehicle, detect the lane the first vehicle is in, determined as a function of data captured by the computer vision system in the first vehicle; and, send telemetry to at least a second vehicle driving behind the first vehicle, wherein the telemetry indicates the second vehicle should move to another lane.

According to an embodiment of the present invention, an event detecting sensor and alert system in a vehicle comprises: one or more processor; one or more sensor, operably connected to the one or more processor; and, a memory, operably coupled with the one or more processor, the memory encoding data and processor executable program instructions, that when executed by the one or more processor, cause the one or more processor to perform operations comprising: determine when the vehicle has been parked, based on data from the one or more sensor; in response to determining the vehicle has been parked, receive new sensor data from the one or more sensor for a predetermined period of time; update a baseline environmental noise floor model by adding the new baseline sensor data to the model, to determine the new baseline environmental noise floor modeled at the location and time the vehicle was parked; detect the occurrence of an event determined as a function of live sensor data filtered as a function of the updated baseline environmental noise floor model; and, send to a remote processing system an event message payload generated as a function of the detected event.

According to an embodiment of the present invention, the one or more sensor further comprises an accelerometer.

According to an embodiment of the present invention, the one or more sensor further comprises a barometric pressure sensor.

According to an embodiment of the present invention, the one or more sensor further comprises a hygrometer.

According to an embodiment of the present invention, the one or more sensor further comprises a magnetometer.

According to an embodiment of the present invention, the one or more sensor further comprises an audio microphone.

According to an embodiment of the present invention, the one or more sensor further comprises a camera.

According to an embodiment of the present invention, the baseline environmental noise floor model further comprises vibration data.

According to an embodiment of the present invention, the baseline environmental noise floor model further comprises seismic data.

According to an embodiment of the present invention, the baseline environmental noise floor model further comprises weather data.

According to an embodiment of the present invention, the baseline environmental noise floor model further comprises audio data.

According to an embodiment of the present invention, the baseline environmental noise floor model further comprises image data.

According to an embodiment of the present invention, the baseline environmental noise floor model further comprises video data.

According to an embodiment of the present invention, the event detecting sensor and alert system in a vehicle further comprises: a wireless mesh network interface operably connected to the one or more processor to govern communication with each vehicle of a plurality of other vehicles, and the operations performed by the one or more processor further comprise: sending the baseline environmental noise floor model to another vehicle of the plurality of other vehicles.

According to an embodiment of the present invention, the event detecting sensor and alert system in a vehicle further comprises: a wireless mesh network interface operably connected to the one or more processor to govern communication with each vehicle of a plurality of other vehicles, and the operations performed by the one or more processor further comprise: receiving a baseline environmental noise floor model from each vehicle of the plurality of other vehicles; creating a macro environmental noise floor model based on fusing each of the baseline environmental noise floor models received from each vehicle of the plurality of other vehicles; and, providing macro environmental noise floor model access to a decision maker, to generate predictive analytic output based on live sensor data captured by the plurality of vehicles.

According to an embodiment of the present invention, the decision maker further comprises a geology research organization.

According to an embodiment of the present invention, the decision maker further comprises a meteorological research organization.

According to an embodiment of the present invention, an event detecting sensor and alert system in a vehicle comprises: one or more processor; an accelerometer, operably connected to the one or more processor; one or more RF (radio frequency) sensor, operably connected to the one or more processor; and, a memory, operably coupled with the one or more processor, the memory encoding data and processor executable program instructions, that when executed by the one or more processor, cause the one or more processor to perform operations comprising: determine when the vehicle has been parked, based on data from the accelerometer; in response to determining the vehicle has been parked, receive new RF sensor data from the one or more RF sensor for a predetermined period of time; update a baseline environmental RF noise floor model by adding the new RF sensor data to the model, to determine the new baseline environmental RF noise floor modeled at the location and time the vehicle was parked; detect a wireless hacking attempt determined as a function of live RF sensor data filtered as a function of the updated baseline environmental RF noise floor model; and, in response to detecting a wireless hacking attempt: implement a response directed to mitigate the detected wireless hacking attempt; and, send to a remote processing system an event message payload generated as a function of the detected wireless hacking attempt.

According to an embodiment of the present invention, the one or more RF sensor includes a Bluetooth, cellular, WiFi, Loran, Zigbee, or sub-gigahertz RF sensor.

According to an embodiment of the present invention, the operations performed by the one or more processor further comprise identifying specific signal emitters as a function of frequency, time active, and signal strength.

According to an embodiment of the present invention, the operations performed by the one or more processor further comprise identifying specific signal emitters as a function of MAC address, Bluetooth address, or MEID.

According to an embodiment of the present invention, the operations performed by the one or more processor further comprise tracking identified signal emitters over time.

According to an embodiment of the present invention, the operations performed by the one or more processor further comprise building a predictive analytic model based on the identified signal emitters tracked over time.

According to an embodiment of the present invention, the operations performed by the one or more processor further comprise predicting the probability a signal is malicious, determined as a function of the tracked history of the signal predictive analytic model.

According to an embodiment of the present invention, the operations performed by the one or more processor further comprise determining a signal is malicious if the signal is unknown to the baseline model and the signal emitter is determined to be within a predetermined minimum distance of the vehicle for a predetermined minimum period of time.

According to an embodiment of the present invention, the operations performed by the one or more processor further comprise in response to determining a signal is malicious, shut down one or more wireless interface to the vehicle.

According to an embodiment of the present invention, the operations performed by the one or more processor further comprise in response to determining a signal is malicious, shut down all wireless access to the vehicle, and require a physical key to unlock the vehicle.

According to an embodiment of the present invention, the operations performed by the one or more processor further comprise in response to determining a signal is malicious, shut down all wireless access to the vehicle, and require a predetermined identification number entered in a physical keypad disposed on a vehicle exterior surface to unlock the vehicle.

According to an embodiment of the present invention, the operations performed by the one or more processor further comprise in response to determining a signal is malicious, shut down all wireless access to the vehicle, and require a fingerprint scanned from a physical finger in contact with a fingerprint scanner disposed on a vehicle exterior surface to unlock the vehicle.

According to an embodiment of the present invention, the operations performed by the one or more processor further comprise in response to determining a signal is malicious, shut down all wireless access except NFC (Near Field Communication) to the vehicle, and require a predetermined identification number communicated via NFC from an authenticated mobile device to unlock the vehicle.

According to an embodiment of the present invention, an event detecting sensor and alert system in a vehicle comprises: one or more processor; an accelerometer, operably connected to the one or more processor; one or more capacitance sensor configured to measure the capacitance of at least one vehicle surface, the one or more capacitance sensor operably connected to the one or more processor; and, a memory, operably coupled with the one or more processor, the memory encoding data and processor executable program instructions, that when executed by the one or more processor, cause the one or more processor to perform operations comprising: detect when an object is scraped against the vehicle, determined as a function of accelerometer data; in response to detecting the object scraped against the vehicle, measure the frequency of the vibration due to the object scraped against the vehicle; determine if the frequency of the vibration due to the object scraped against the vehicle matches a frequency predetermined as a vehicle scratching signature frequency; and, in response to determining the frequency matches a vehicle scratching signature frequency, send to a remote processing system an event message payload generated as a function of the detected vehicle scratching attempt.

According to an embodiment of the present invention, the event detecting sensor and alert system in the vehicle further comprises the one or more capacitance sensor wirelessly connected to the one or more processor.

According to an embodiment of the present invention, the event detecting sensor and alert system in the vehicle further comprises the one or more capacitance sensor electrically connected to the one or more processor.

According to an embodiment of the present invention, the operations performed by the one or more processor further comprise: in response to detecting the object scraped against the vehicle, determine the capacitance of the surface against which the object is scraped, to determine the change in the at least one surface's capacitance while the object is scraped against the vehicle; determine if the change in capacitance matches a capacitance change predetermined as a vehicle scratching capacitance change; and in response to determining the capacitance change matches a vehicle scratching capacitance change, send to a remote processing system an event message payload generated as a function of the detected vehicle scratching attempt.

According to an embodiment of the present invention, the operations performed by the one or more processor further comprise: monitoring the capacitance of at least one vehicle surface, based on data from the capacitance sensor; in response to detecting a change in the capacitance of the at least one vehicle surface, determine if the change in the at least one surface's capacitance matches a capacitance change predetermined as a vehicle painting capacitance change; and in response to determining the capacitance change matches a vehicle painting capacitance change, send to a remote processing system an event message payload generated as a function of the detected vehicle painting attempt.

According to an embodiment of the present invention, the event detecting sensor and alert system in the vehicle further comprises a camera operably connected to the one or more processor, and the operations performed by the one or more processor further comprise: in response to detecting a vehicle scratching attempt, determine the location scratched on the vehicle based on capacitance sensor data; activate the camera to take a picture in the direction of the vehicle location scratched; and, send to a remote processing system the picture included with an event message payload generated as a function of the detected vehicle scratching attempt.

According to an embodiment of the present invention, an event detecting sensor and alert system buoy in a swimming pool comprises: one or more processor; one or more sensor, operably connected to the one or more processor; and, a memory, operably coupled with the one or more processor, the memory encoding data and processor executable program instructions, that when executed by the one or more processor, cause the one or more processor to perform operations comprising: receive sensor data from the one or more sensor; detect the occurrence of an event determined as a function of the sensor data; and, send to a remote processing system an event message payload generated as a function of the detected event.

According to an embodiment of the present invention, the one or more sensor further comprises an accelerometer.

According to an embodiment of the present invention, an event detecting sensor and alert system further comprises a solar panel configured to power the event detecting sensor and alert system.

According to an embodiment of the present invention, an event detecting sensor and alert system buoy is waterproof

According to an embodiment of the present invention, the operations performed by the processor further comprise: determine when the pool is not in use, based on comparing pool surface fluid vibration data determined as a function of live accelerometer data captured from the floating buoy and a pool surface fluid vibration profile characterizing historical pool surface fluid vibration data captured from the floating buoy when the pool is at rest; upon determining the pool is at rest based on the comparison, monitor for a predetermined period of time the pool surface fluid vibration based on live accelerometer data captured from the floating buoy, to detect a change in the pool surface fluid vibration; upon detecting a change in the pool surface fluid vibration, compare the change to a predetermined vibration change threshold based on a vibration change model constructed as a function of historical pool vibration data and pool event outcomes, to determine if the vibration change is due to an inanimate object impacting the pool, based on the comparison; in response to determining the vibration change is not due to an inanimate object impacting the pool, send to a remote processing system an event message payload generated as a function of the detected pool impact event.

According to an embodiment of the present invention, the vibration change model further comprises vibration data characterizing a drowning person in the pool.

According to an embodiment of the present invention, the vibration change model further comprises vibration data characterizing an inanimate object in the pool.

### BRIEF DESCRIPTION OF THE DRAWINGS

FIG. 1 illustrates a schematic overview of an event detecting sensor and alert system, in accordance with an embodiment of the present invention.

FIG. 2 illustrates a network schematic of a system, in accordance with an embodiment of the present invention.

FIG. 3 illustrates a schematic of a system for providing a multipurpose event detection sensor and a communications means for delivering a payload notification, in accordance with an embodiment of the present invention.

FIG. 4 illustrates a schematic of a system for providing a multipurpose event detection sensor and a communications means for delivering a payload notification, in accordance with an embodiment of the present invention.

FIG. 5 is a process flow of an exemplary method in accordance with embodiments of the present invention.

FIG. 6 is a process flow of an exemplary method in accordance with embodiments of the present invention.

FIG. 7 is a side perspective view of an exemplary event detecting sensor and alert system in an illustrative consumer delivery scenario.

FIG. 8 is a side perspective view of exemplary event detecting sensor and alert systems in assembled and opened configurations.

FIG. 9 is a side plan view of an exemplary event detecting sensor and alert system in an opened configuration.

FIG. 10 is a block diagram depicting an exemplary event detecting sensor and alert system connection to a vehicle power bus.

FIG. 11 is an illustration depicting an exemplary event detecting sensor and alert system installation scenario.

FIG. 12 is an illustration depicting an exemplary installed event detecting sensor and alert system.

FIG. 13 is a side view of exemplary event detecting sensor and alert system vibration characteristics.

FIG. 14 is a signal graph depicting an exemplary event detecting sensor and alert system power bus communication protocol.

FIG. 15 is an illustration depicting exemplary event detecting sensor and alert system sensor locations on a vehicle.

FIG. 16 is an illustration depicting exemplary vehicle impact locations.

FIG. 17 is an illustration depicting the beginning of an exemplary vehicle impact scenario.

FIG. 18 is an illustration depicting the beginning of an exemplary vehicle impact scenario.

FIG. 19 is an illustration depicting an exemplary event detecting sensor and alert system vehicle impact detection scenario.

FIG. 20 is an illustration depicting an exemplary event detecting sensor and alert system vehicle impact event message payload generation scenario.

FIG. 21 is an illustration depicting an exemplary event detecting sensor and alert system vehicle impact event message payload delivery scenario.

FIG. 22 is a process flow of an exemplary event detecting sensor and alert system power line communication sender scenario.

FIG. 23 is a process flow of an exemplary event detecting sensor and alert system power line communication receiver scenario.

FIG. 24 is a process flow of an exemplary event detecting sensor and alert system baseline noise floor event detection scenario.

FIG. 25 is a process flow of an exemplary event detecting sensor and alert system lug nut torque event detection scenario.

FIG. 26 is a process flow of an exemplary event detecting sensor and alert system multi-vehicle mesh network event detection scenario.

### DETAILED SPECIFICATION

According to an embodiment of the present invention, a multipurpose event detection sensor and a communications means for delivering a payload notification is disclosed herein. In a preferred embodiment, the multipurpose event detection sensor comprises integrated circuitry for detecting one or more types of events, such as vibration, sound, acceleration, impact, or any combination thereof. The sensor further comprises a processing unit configured to analyze events detected by the sensor and analyze the events for relevance (e.g., events exceeding a predetermined threshold). To the extent an event is determined by the processing unit to be relevant, the system will generate an alert based on the detected event and transmit the alert to a remote system for processing and delivery. A full detail of the invention is provided herein.

In a preferred embodiment, disclosed herein is a hardware and/or software sensor capable of detecting an event found within an automobile (for example, one from 1996 or later), and producing and/or sending a payload notification (for example, utilizing the MQTT, HTTPS or other RESTful protocol) via autodialing a wireless connection (for example, over a cellular 3G connection) to a remote device (for example, one found on Amazon Web Services) as a response. It comprises generally of a grouping of Integrated Circuits (for example, an ADXL345) capable of performing a multitude of functions, identifying vibrations of varying forms and amplitudes, in response to numerous events ranging from impacts in varying degrees of severity, to those from audible sources, to others.

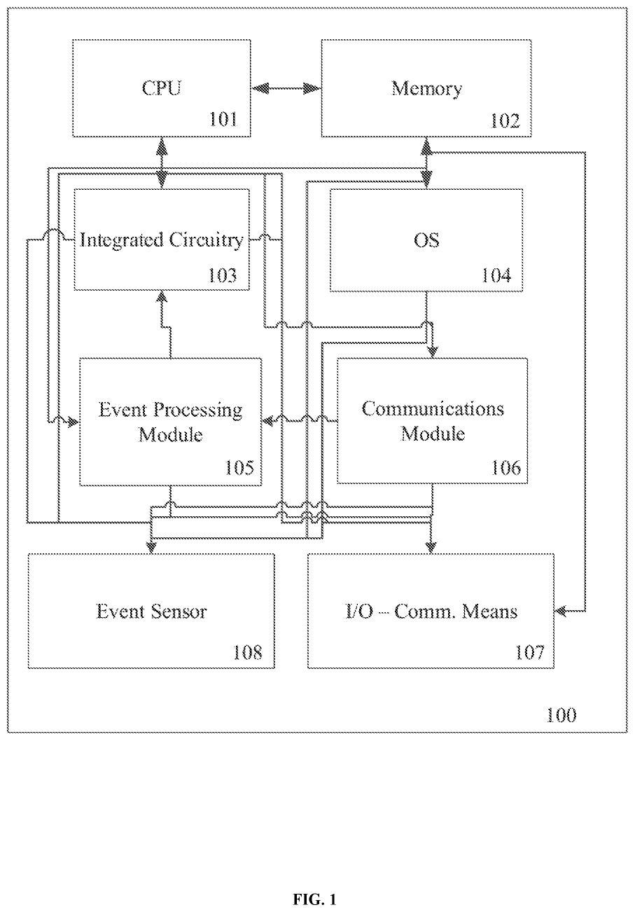

According to an embodiment of the present invention, the system and methods described herein are accomplished through the use of one or more event detecting sensor and alert systems. As shown in FIG. 1, in a preferred embodiment of the present invention, an event detecting sensor and alert system 100 appropriate for use with embodiments of the present application may generally be comprised of one or more of a Central processing Unit (CPU) 101, Memory (e.g, Random Access Memory (RAM)) 102, integrated circuitry for communicating between various components 103, an operating system (OS) 104, one or more modules for processing events 105, one or more modules for processing communications 106, one or more input/output means or other communications means 107 and one or more event sensors 108.

In an exemplary embodiment according to the present invention, data may be provided to the system, stored by the system and provided by the system to users of the system across local area networks (LANs) (e.g., WI-FI networks) or wide area networks (WANs) (e.g., the Internet, cellular networks). In accordance with the previous embodiment, an event detecting sensor and alert system may communicate alerts to any number of remote computing devices (e.g., servers) communicatively connected across one or more LANs and/or WANs in order to facilitate further processing of detected events. One of ordinary skill in the art would appreciate that there are numerous manners in which the system could be configured and embodiments of the present invention are contemplated for use with any configuration.

According to an embodiment of the present invention, some of the applications of the present invention may not be accessible when an event detecting sensor and alert system is not connected to a network, however the event detecting sensor and alert systems may be able to compose alerts offline that will be consumed by a remote computing system when the event detecting sensor and alert system is later connected to a network.

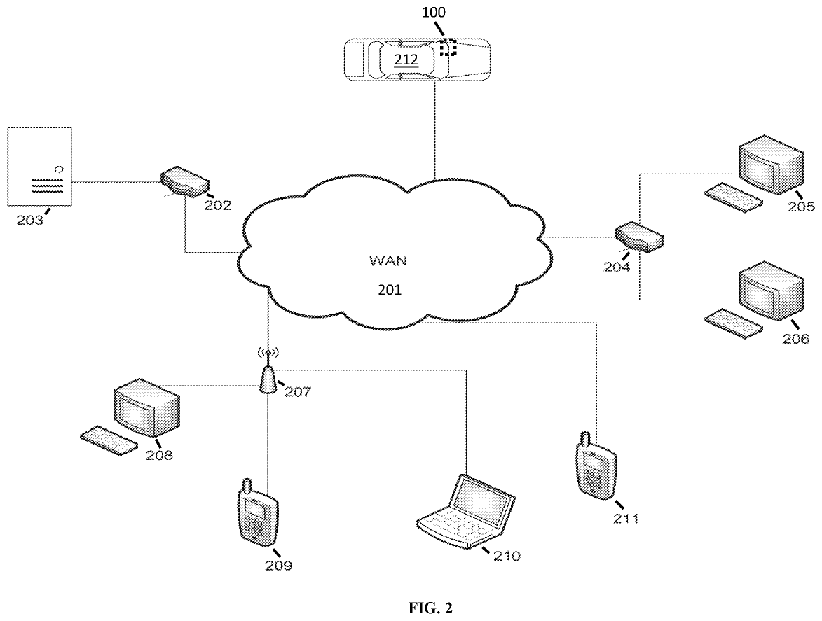

Referring to FIG. 2, a schematic overview of a networked portion of a system in accordance with an embodiment of the present invention is shown. The system is comprised of one or more application servers 203 for electronically receiving, processing and transmitting events provided by one or more event detecting sensor and alert system 100 configured in the vehicle 212. Applications in the application server 203 may retrieve and manipulate information in storage devices and exchange information through a Network 201 (e.g., the Internet, a LAN, WiFi, Bluetooth, etc.). Applications in server 203 may also be used to manipulate information stored remotely and process and analyze data stored remotely across a Network 201 (e.g., the Internet, a LAN, WiFi, Bluetooth, etc.).

According to an exemplary embodiment, as shown in FIG. 2, exchange of information through the Network 201 may occur through one or more connections. In some cases, connections may be over-the-air (OTA), passed through networked systems, directly connected to one or more Networks 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to Network 201 for the exchange of information with an event detecting sensor and alert system 100 or other devices (e.g., end user computing devices), and embodiments of the present invention are contemplated for use with any method for connecting to networks for the purpose of exchanging information. Further, while this application refers to high speed connections, embodiments of the present invention may be utilized with connections of any speed.

In a preferred embodiment of the present invention, an event detecting sensor and alert system 100 may connect to server 203 via Network 201. The server 203, upon receiving and processing an alert from the event detecting sensor and alert system 100, may provide processed alert information to end users of the system, such as: i) through feedback directly to the automobile associated with the event detecting sensor and alert system 100, such automobile being directly connected to the Network 201, with processed alert information being provided through one or more processing means associated with the automobile (e.g., integrated entertainment system), ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the Network 201. One of ordinary skill in the art would appreciate that there are numerous ways that a component may connect to server 203 via Network 201, and embodiments of the present invention are contemplated for use with any method for connecting to server 203 via Network 201. Furthermore, server 203 could be comprised of a personal computing device, such as a smartphone, acting as a host for other computing devices to connect to.

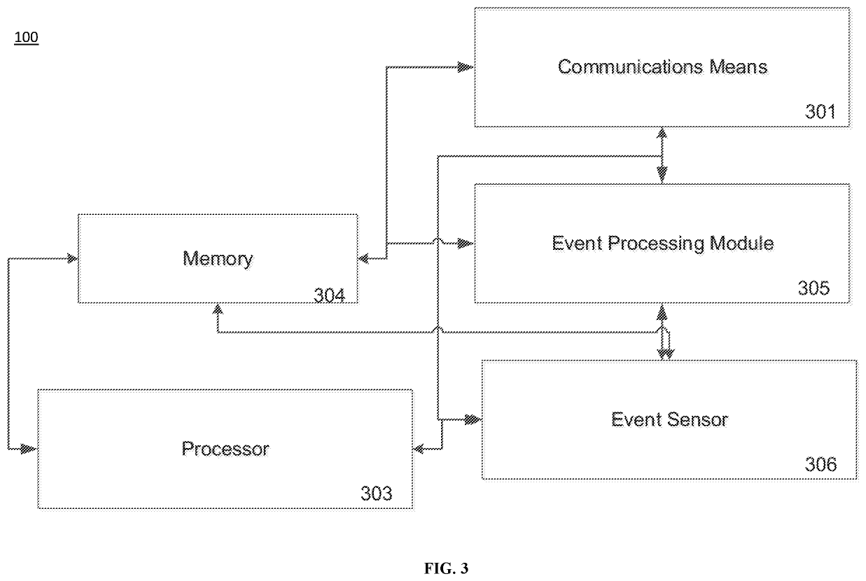

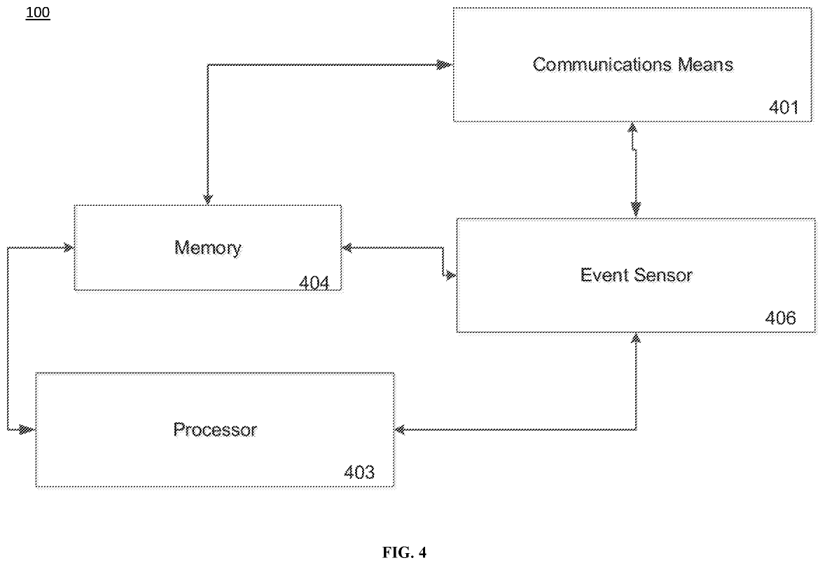

Turning to FIG. 3, according to an embodiment of the present invention, the exemplary event detecting sensor and alert system 100 is comprised of one or more communications means 301, a processor 303, memory 304, an event processing module 305 and an event sensor 306. In FIG. 4, according to an embodiment of the present invention, the exemplary event detecting sensor and alert system 100 is comprised of one or more communications means 401, a processor 403, memory 404, and an event sensor 406. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the communications means of the system may be, for instance, circuitry purposed for the means of communicating data, voice or video communications (or any combination thereof) over one or more networks or to one or more peripheral devices attached to the system. Appropriate communications means may include, but are not limited to, circuitry and or other electronics or combinations of software, hardware and individual elements thereof, each providing for one or more wireless connections, wired connections, cellular connections, data port connections, Bluetooth connections, fiber optic connections, modems, network interface cards or any combination thereof. One of ordinary skill in the art would appreciate that there are numerous communications means that may be utilized with embodiments of the present invention, and embodiments of the present invention are contemplated for use with any communications means.

According to an embodiment of the present invention, the event sensor generally comprises hardware (e.g., circuitry), software or a combination thereof, configured to sense one or more types of events that would be relevant to and warrant generation of an alert. In a preferred embodiment, the event sensor may be comprised of one or more accelerometers or other device capable of sensing movement or vibration. In other embodiments, an event sensor could be comprised of one or more audio sensors (e.g., glass break sensors, microphones, directional microphones), temperature sensors, hall effect sensors, or any combination thereof. One of ordinary skill in the art would appreciate that there are numerous types of sensors that could be utilized with embodiments of the present invention, and embodiments of the present invention are contemplated for use with any appropriate sensor types.

According to an embodiment of the present invention, multiple sensors can be utilized in conjunction with one another in order to provide more detailed and sensitive responses. For instance, utilizing two accelerometers to detect movement, impact or vibration, could provide additional details with regards to an event. For instance, if an accelerometer was placed in the front of a vehicle and another in the rear, an impact in the rear would first be detected (even if only separated by, for instance, milliseconds) by the rear accelerometer and then rapidly thereafter be detected by the front accelerometer. Having this differentiation can provide information about the significance of an event, including severity at more than one event location, and directional information (e.g., such as in the case of using two audio sensors to create a stereo effect). One of ordinary skill in the art would appreciate how a combination of sensors could provide a greater level of detail and granularity with respect to events, and embodiments of the present invention are contemplated for use with any appropriate combination of sensors. In some cases, the location on a vehicle of an impact may be determined from sensor data as a function of the sensor location. For example, given the accelerometer location and orientation, the acceleration vector provided by sensor data captured from an impact event may be used to calculate the point of impact. In an illustrative example, accelerometer data may be tracked over time to determine the accelerometer orientation. In some cases, accelerometer data may be fused with other sensor data to determine accelerometer orientation, as the skilled artisan may recognize. For example, accelerometer data may be fused with gyroscope or magnetometer data, to aid determining the accelerometer orientation and improve the accuracy of determining impact location.

According to an embodiment of the present invention, the event processing module is configured to work in conjunction with the processor and event sensors in order to generate appropriate alerts in response to an event. The event processing module receives event data from the event sensors and determines if any particular event is significant and warrants issuance of an alert. Minor events, such as minor environmental events (e.g., wind, rain), that may be detectable by an event sensor will not warrant generation of an event. As such, the event processing module may be configured to utilize various thresholds in order to determine when an event should actually be processed.

Should an event detected by the event sensor(s) cross the threshold determined in the event processing module, the event processing module will generate an alert. An alert may contain all relevant information received from the event sensor, such as severity, duration, location (e.g., which(s) sensor detected the event, what sensor detected the event first), or any combination thereof. In certain embodiments, full processing of the event information will be processed locally. In other embodiments, the raw event information may be transmitted to a remote system for processing into a full alert. In either embodiment, the information (processed, raw or semi-processed) will be transmitted to a remote system for delivery to end user recipients. In some embodiments, the information may be transmitted directly to end user recipients without need for transmission to a middle remote system. Transmission of the information is generally accomplished via interaction with the communications means, which will determine and utilize the appropriate connection in order to process and transmit the information.

In a preferred embodiment, a remote system will receive the event information and process the event information into a payload for delivery to one or more end user devices. For instance, a server may receive the information over a network connection, where the communications means of the event detecting sensor and alert system transmitted the information to the network via a connection (e.g., WIFI, cellular, satellite). Once the server receives the information from the event detecting sensor and alert system, the server processes the payload for delivery to the end user devices by determining the relevant criteria, such as type of event and severity.

In certain embodiments, the server may be configured to determine which end user devices to transmit the payload to is based at least in part on criteria of the event. For instance, in certain embodiments, the system may be configured to send alerts to emergency personnel where the severity of an event reaches a significant threshold. In other embodiments, the system may be configured to send alerts only to registered users associated with the event detecting sensor and alert system. One of ordinary skill in the art would appreciate that there are numerous criteria that could be utilized for determining which end user devices to send a payload to, and embodiments of the present invention are contemplated for use with any appropriate determination criteria.

### EXEMPLARY EMBODIMENTS

Turning now to FIG. 5, an exemplary method for providing an event detecting sensor and alert system is shown, in accordance with an embodiment of the present invention. FIG. 5 details the process as seen from point of view of where the sensors and alert system is mounted, such as on a vehicle. At step 501, the process starts with an event occurring. At step 502, the system detects the event and records event related data (e.g., severity, duration).

At step 503, the system processes an initial analysis of the event to determine if the event is one that requires initializing an event response. If the threshold is not exceeded, the process will terminate (step 508).

However, if the event threshold is exceeded, the process continues to step 505, wherein the system sends the event data for processing. Processing of the event data may include, but is not limited to, recording and identifying the severity and duration of the event, and developing any additional information from the sensor data (e.g., direction, magnitude, type).

At this point, the system then generates the message payload that will be transmitted to the remote system for further processing (step 506). Methods for generation of the payload are detailed elsewhere herein. Once complete, the payload is transmitted to the remote system for processing (step 507), at which point the process terminates (step 508).

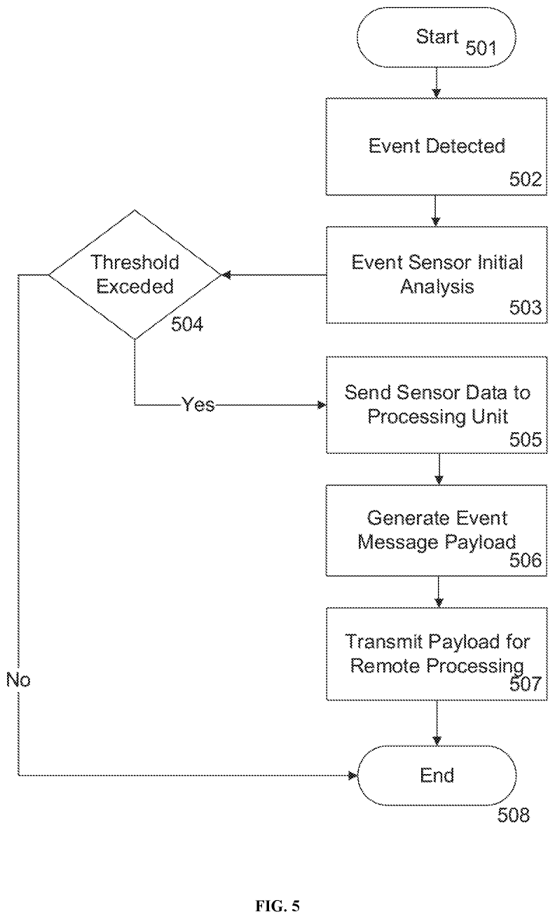

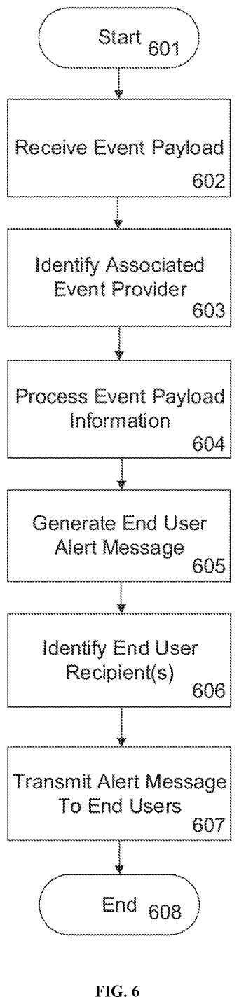

Turning now to FIG. 6, an exemplary method for processing event payloads is shown, in accordance with an embodiment of the present invention. FIG. 6 details the process as seen from point of view of the remote processing system. At step 601, the process starts with an event payload being transmitted to the remote processing system. At step 602, the remote processing system receives the event payload and begins the processing method.

At step 603, the system identifies the event provider. The event provider may be identified, for instance, by a unique identifier (e.g., GUID) associated with a particular event sensing and alert system. Such an identifier may be, for instance, contained in a header of the payload. One of ordinary skill in the art would appreciate that there are numerous methods for identifying an event provider, and embodiments of the present invention are contemplated for use with any appropriate method for identifying an event provider.

At step 604, the system processes the event payload information. Depending on whether the event sensing and alert system previously processed the information, or if raw sensor information is received in the payload, the details of the processing step may vary. For instance, if raw data is received, the system will need to fully process the received data into event specific information data. Where processed data was received, the system will require less local processing and can use the previously processed data in furtherance of the method.

At step 605, the system generates a message that is appropriate for one or more end users. This may include generating details that have been determined by the sensor data and converted into a recreation of the event in relatable terms. For instance, a severe impact detected by one or more accelerometers attached to a vehicle, may be converted into a message that indicates that a significant collision event has occurred and that the owner may want to immediately check on their vehicle (if not present in the vehicle). Further, if as indicated previously herein, a message is to be generated for emergency personnel or others that may not be directly associated with the event provider, additional information may also be included, such as location information (e.g, provided by global positioning data or other location based services) of the event provider and type and severity of the event.

At step 606, the system identifies the end user recipients that will be provided the message or messages generated by the system. End user recipients may include those that are associated with the event provider (e.g., owner of a vehicle), local emergency personnel (e.g., emergency personnel most proximate to the identified location of the event provider), or any combination thereof.

At step 607, the system will transmit the messages to the relevant end users. At this point the process will terminate (step 608).

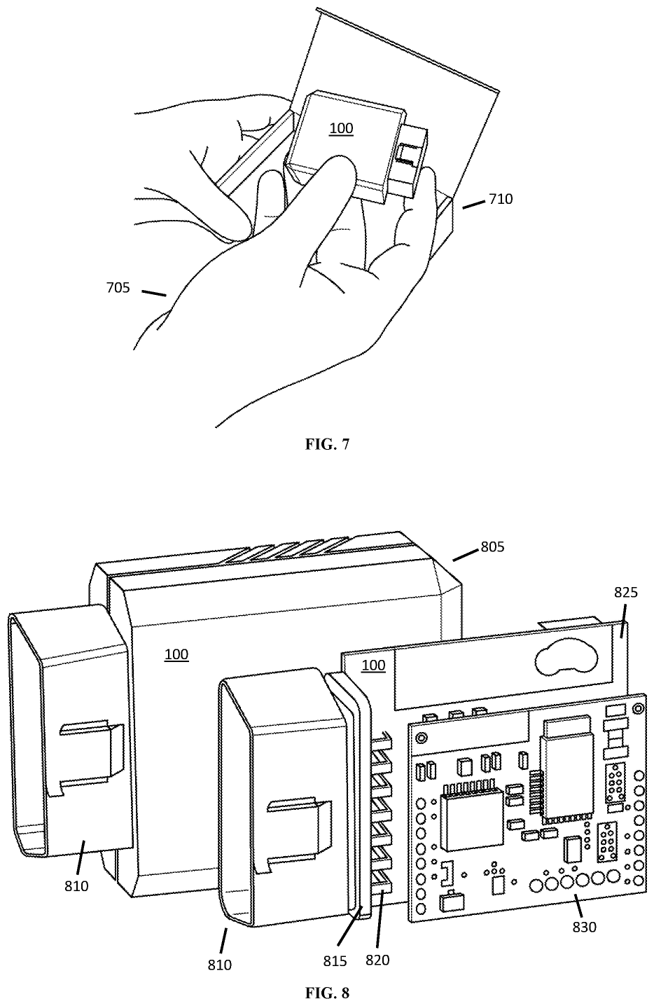

FIG. 7 is a side perspective view of an exemplary event detecting sensor and alert system in an illustrative consumer delivery scenario. In FIG. 7, the user 705 removes the exemplary event detecting sensor and alert system 100 from the consumer shipping package 710.

FIG. 8 is a side perspective view of exemplary event detecting sensor and alert systems in assembled and opened configurations. In FIG. 8, the exemplary event detecting sensor and alert system 100 head unit includes the case 805 and diagnostic port connector 810 in an illustrative assembled configuration. In the depicted example, the exemplary event detecting sensor and alert system 100 in an opened configuration illustrates the diagnostic port connector 810 interface through the connection harness 815 to the printed circuit board connector pins 820. The connection harness 815 and the printed circuit board connector pins 820 together form a right-angle adapter connecting the event detecting sensor and alert system 100 to the diagnostic port connector 810, without direct contact between the circuit board and the diagnostic port connector 810. In the illustrated example, the exemplary event detecting sensor and alert system 100 includes the main printed circuit board 825 to which the daughter printed circuit board 830 is mounted.

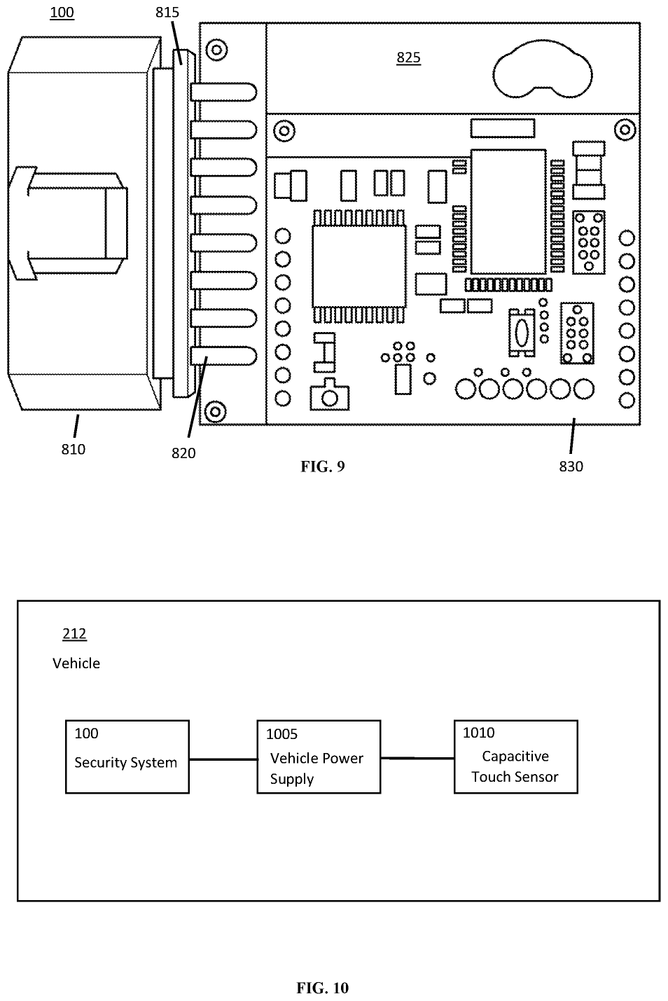

FIG. 9 is a side plan view of an exemplary event detecting sensor and alert system in an opened configuration. In FIG. 9, the exemplary event detecting sensor and alert system 100 includes the diagnostic port connector 810 interface through the connection harness 815 to the printed circuit board connector pins 820 and the main printed circuit board 825 to which the daughter printed circuit board 830 is mounted.

FIG. 10 is a block diagram depicting an exemplary event detecting sensor and alert system connection to a vehicle power bus. In FIG. 10, the exemplary vehicle 212 includes the embodiment event detecting sensor and alert system 100 connected to the vehicle power supply bus 1005. In the depicted example, the capacitive touch sensor 1010 is also connected to the vehicle power supply bus 1005. In the illustrated example, the capacitive touch sensor 1010 and the event detecting sensor and alert system 100 are operably configured to receive electrical power from the vehicle power supply bus 1005. In the depicted example, the capacitive touch sensor 1010 and the event detecting sensor and alert system 100 are operably configured to exchange data through the vehicle power supply bus 1005. In the illustrated example, the capacitive touch sensor 1010 and the event detecting sensor and alert system 100 include communications means configured to send and receive data in the form of a voltage signal superimposed on the vehicle power supply bus 1005 supply voltage. The communications means configured to send and receive data in the form of the voltage signal on the power supply bus 1005 may include a charge pump. The communications means configured to send and receive data in the form of the voltage signal on the power supply bus 1005 may include a level shifter. In an illustrative example, the depicted design may permit reliable communication of capacitive touch events sensed by the capacitive touch sensor 1010 to the event detecting sensor and alert system 100 without an explicit wired or wireless data signal connection, to enhance security, reliability, and prevent attacks against the event detecting sensor and alert system 100. For example, designing the capacitive touch sensor 1010 to communicate touch events to the event detecting sensor and alert system 100 via the power supply bus 1005 eliminates the need for a wired or wireless signal connection which would offer a single point of attack whereby a malicious actor could cut the wired signal connection, or jam the wireless signal connection, and thereby defeat the capacitive touch sensing feature. In addition, such a design avoids degrading the capability of the event detecting sensor and alert system 100 to detect small, minute vibrations through sensitive accelerometer measurement, by eliminating the need for a wired signal connection to a sensor. Providing a data connection between the event detecting sensor and alert system 100 by such a power bus communication link design eliminates the need to connect an antenna to the sensor for wireless data communication. In an illustrative example, connecting an antenna to the sensor may degrade the ability of the sensor to detect events, by disrupting sensor electrical or mechanical characteristics. Providing the sensor data signal via the power bus thus avoids a single point of attack that could defeat system security, and improves the effectiveness of event sensing, based on modulating communication over the power supply connection. Although the capacitive touch sensor 1010 communication is described with reference to FIG. 10, other sensor types could be used in the depicted configuration, as the skilled artisan would recognize. In an illustrative example, such a power line communication protocol may be advantageous in a variety of application areas. For example, in a data center application, an embodiment event detecting sensor and alert system 100 may be bolted to a panel on the data center, to protect vital data center equipment from tampering, with increased reliability to initiate a response to detected tampering, due to hardening to attacks against sensor communication links.

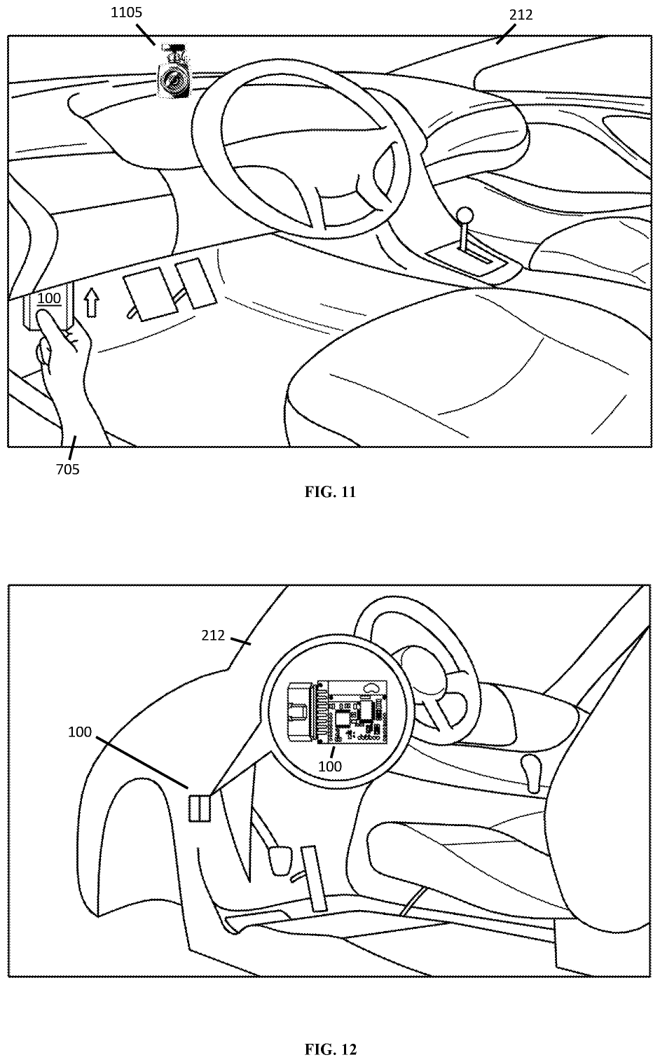

FIG. 11 is an illustration depicting an exemplary event detecting sensor and alert system installation scenario. In FIG. 11, the user 705 installs the exemplary event detecting sensor and alert system 100 in the vehicle 212 OBD-II (On Board Diagnostics II) port. In the depicted example, the camera 1105 is operably configured to provide imaging service directed by the event detecting sensor and alert system 100.

FIG. 12 is an illustration depicting an exemplary installed event detecting sensor and alert system. In FIG. 12, the exemplary event detecting sensor and alert system 100 is depicted installed in the vehicle 212.

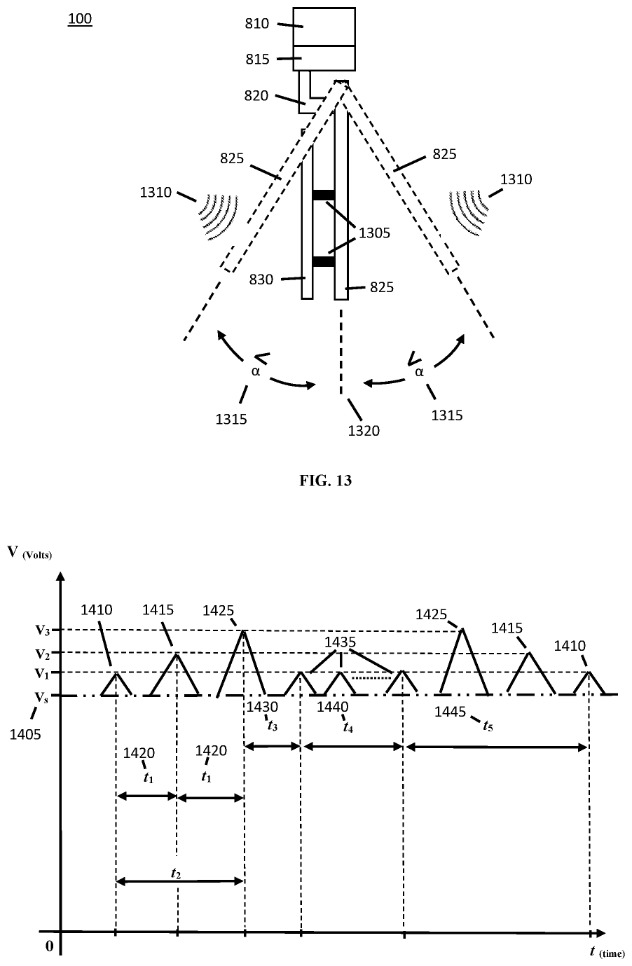

FIG. 13 is a side view of exemplary event detecting sensor and alert system vibration characteristics. In FIG. 13, the exemplary event detecting sensor and alert system 100 includes the diagnostic port connector 810 interface through the connection harness 815 to the printed circuit board connector pins 820 and the main printed circuit board 825, to which the daughter printed circuit board 830 is mounted by spacers 1305. In the depicted example, vibration energy 1310 incident on the event detecting sensor and alert system 100 causes the main printed circuit board 825 to oscillate with angular displacement 1315 to the main printed circuit board 825 longitudinal axis 1320. The depicted angular displacement 1315 illustrates an example of vibration impacting the event detecting sensor and alert system 100 and is not to be interpreted as if drawn to scale. In the illustrated example, the mechanical design includes the main printed circuit board 825 connector pins 820 that connect via the diagnostic port connector 810 into a vehicle OBDII port. The depicted design is a mechanically resonant structure similar to a sensitive tuning fork, with an accelerometer placed along a circuit board length in parallel to the circuit board. The accelerometer may be mounted to the circuit board at some displacement from the connector pins 820. In an illustrative example, such a design permits identifying small but high frequency type impacts, such as, for example, a tennis ball hitting the window, based on data from the accelerometer, while preserving the accelerometer capability to measure larger impacts. Such a design improves detection sensitivity for single-accelerometer applications, reducing cost while improving detection effectiveness based on reducing the need for more than one accelerometer to detect small impacts. For example, such a small impact may create a very small moment of vibration, that is detectable through the mechanically resonant structure provided by such a design.

FIG. 14 is a signal graph depicting an exemplary event detecting sensor and alert system power bus communication protocol. In FIG. 14, the power supply bus 1005 (depicted by FIG. 10) supply voltage 1405 is a direct current voltage on the power supply bus 1005 with reference to the vehicle 212 (depicted by FIG. 10) ground. In the depicted example, exemplary devices communicatively connected to exchange data via the power supply bus 1005 may employ the communication protocol illustrated by FIG. 14 based on superimposing a voltage data signal on the supply voltage 1405. The voltage data signal may be in the range of 100 mV to 1 V. An exemplary message start phase includes the start signal voltage 1410 followed by start signal voltage 1415 after no more than time period 1420. In an illustrative example, if start signal voltage 1415 is not detected within time period 1420, the message start phase is invalid, and sender and receiver should time out and reinitialize the communication link. In the depicted example, start signal voltage 1425 follows start signal voltage 1415 after no more than time period 1420, and the message start phase is complete. Then, the message content phase begins after no more than time period 1430, with one or more message data signal 1435 within a maximum message content phase time period 1440. Then, the message end phase completes within no more than time period 1445, with the message start phase start signal voltages 1425, 1415, and 1410 in reverse order from the message start phase. In the illustrated example, a valid message has been received through the power supply bus 1005 when the message start phase, the message content phase, and the message end phase have been sent and received without error.

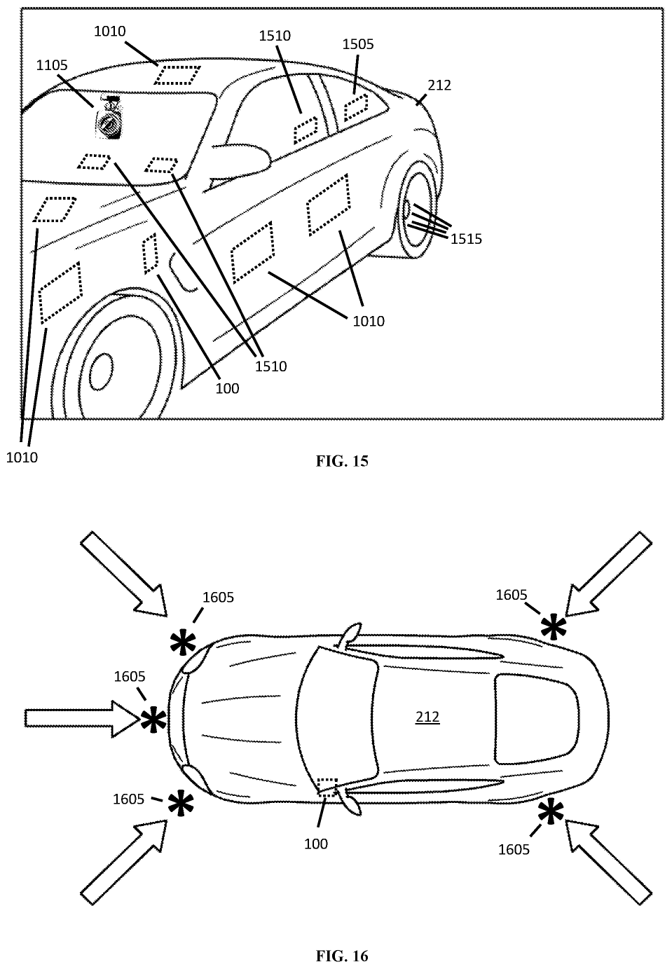

FIG. 15 is an illustration depicting exemplary event detecting sensor and alert system sensor locations on a vehicle. In FIG. 15, the exemplary vehicle 212 includes the exemplary event detecting sensor and alert system 100 configured with capacitive touch sensors 1010 and camera 1105. In the depicted example, the event detecting sensor and alert system 100 is also configured with the barometric sensor 1505, passive IR sensors 1510, and lug nut strain gauge sensors 1515.

FIG. 16 is an illustration depicting exemplary vehicle impact locations. In FIG. 16, the exemplary vehicle 212 is configured to detect and respond to multiple impact 1605 points.

FIG. 17 is an illustration depicting the beginning of an exemplary vehicle impact scenario. In FIG. 17, the user 705 throws the tennis ball 1705 toward the vehicle 212 impact 1605 point on the window 1710. The depicted vehicle 212 event detecting sensor and alert system 100 is armed and monitoring the vehicle 212 security.

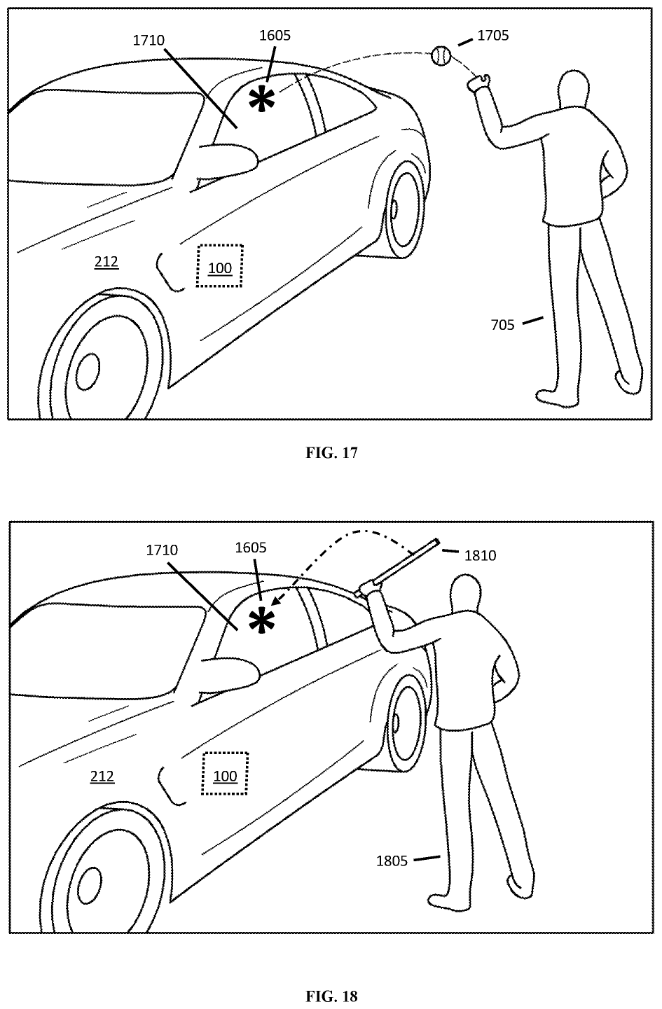

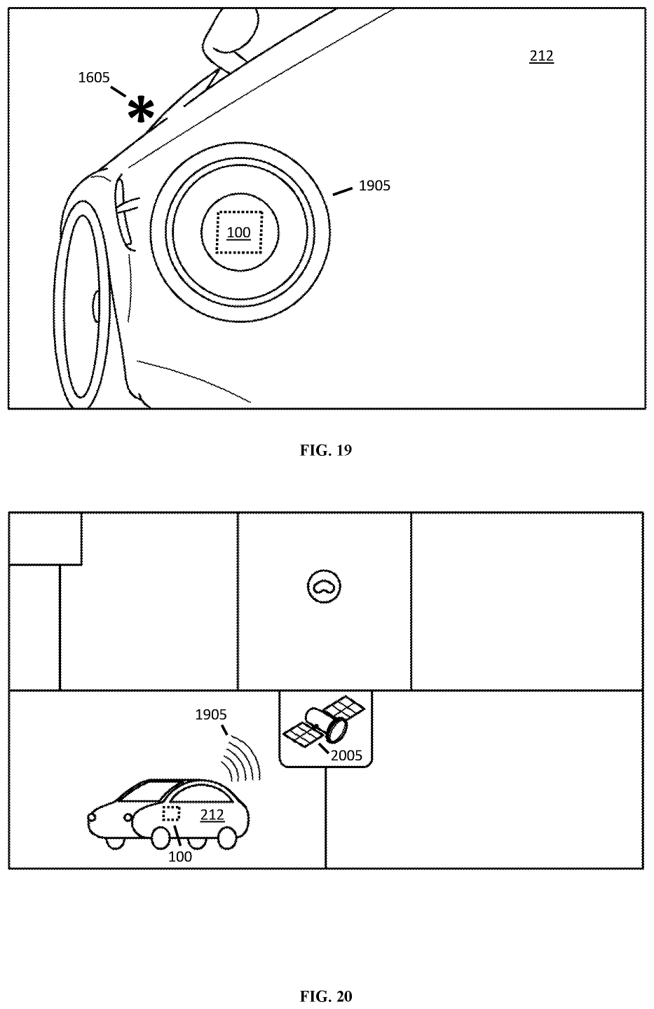

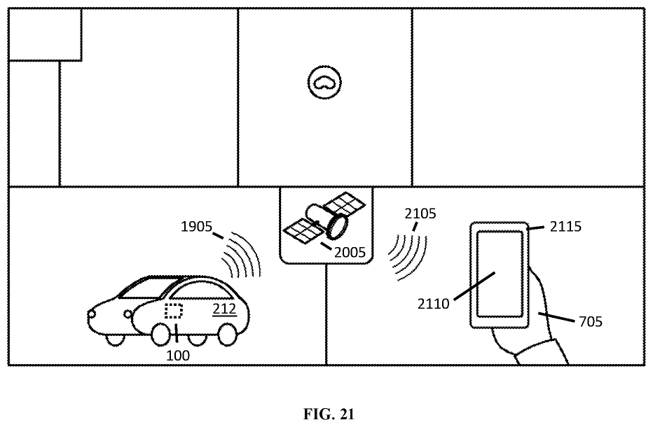

FIG. 18 is an illustration depicting the beginning of an exemplary vehicle impact scenario. In FIG. 18, the malicious actor 1805 swings the weapon 1810 at the vehicle 212 impact 1605 point on the window 1710. The depicted vehicle 212 event detecting sensor and alert system 100 is armed and monitoring the vehicle 212 security.

FIG. 19 is an illustration depicting an exemplary event detecting sensor and alert system vehicle impact detection scenario. In FIG. 19, the depicted vehicle 212 event detecting sensor and alert system 100 detects the impact 1605 and begins generating message payload 1905.

FIG. 20 is an illustration depicting an exemplary event detecting sensor and alert system vehicle impact event message payload generation scenario. In FIG. 20, the depicted vehicle 212 event detecting sensor and alert system 100 sends the generated message payload 1905 through the cloud communication means 2005.

FIG. 21 is an illustration depicting an exemplary event detecting sensor and alert system vehicle impact event message payload delivery scenario. In FIG. 21, the delivered message payload 2105 arrives as event message 2110 on the user 705 mobile device 2115.

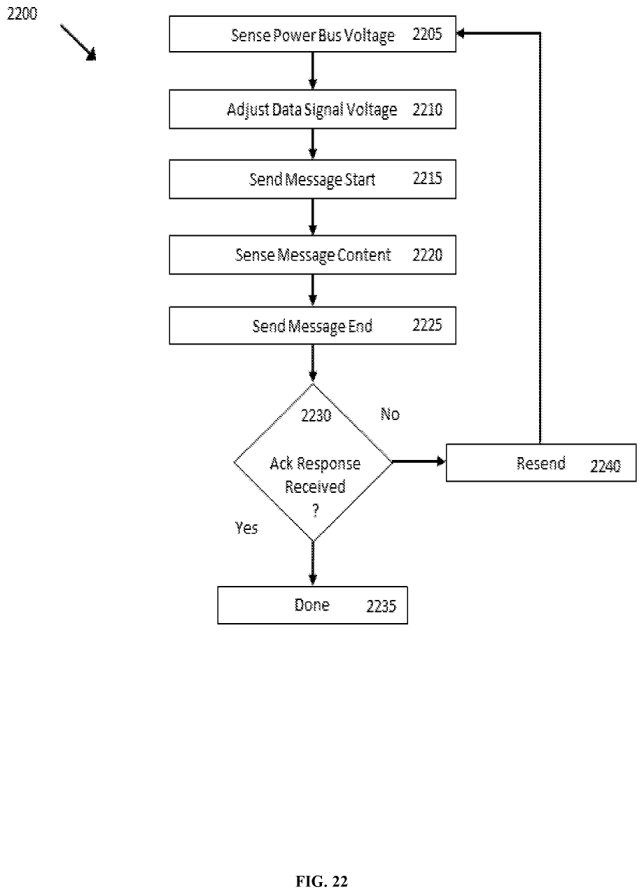

FIG. 22 is a process flow of an exemplary event detecting sensor and alert system power line communication sender scenario. The process depicted by FIG. 22 is given from the perspective of the CPU (processor) 101 in the exemplary event detecting sensor and alert system 100, both depicted at least in FIG. 1. The depicted process 2200 begins at step 2205 with the processor 101 sensing the power bus voltage and adjusting at step 2210 the data signal voltage superimposed on the power bus. Adjusting the data signal voltage may be implemented with a training or learning sequence including applying a test voltage and measuring the result. At step 2215, the processor 101 sends the message start sequence as described with reference to FIG. 14. At step 2220, the processor 101 sends the message content as described with reference to FIG. 14. At step 2225, the processor 101 sends the message end sequence as described with reference to FIG. 14. At step 2230 the processor 101 performs a test to determine if a positive acknowledgement message was received within a predetermined period of time. If no positive acknowledgement was received, the processor 101 resends the message at step 2240, otherwise the process ends at step 2235.

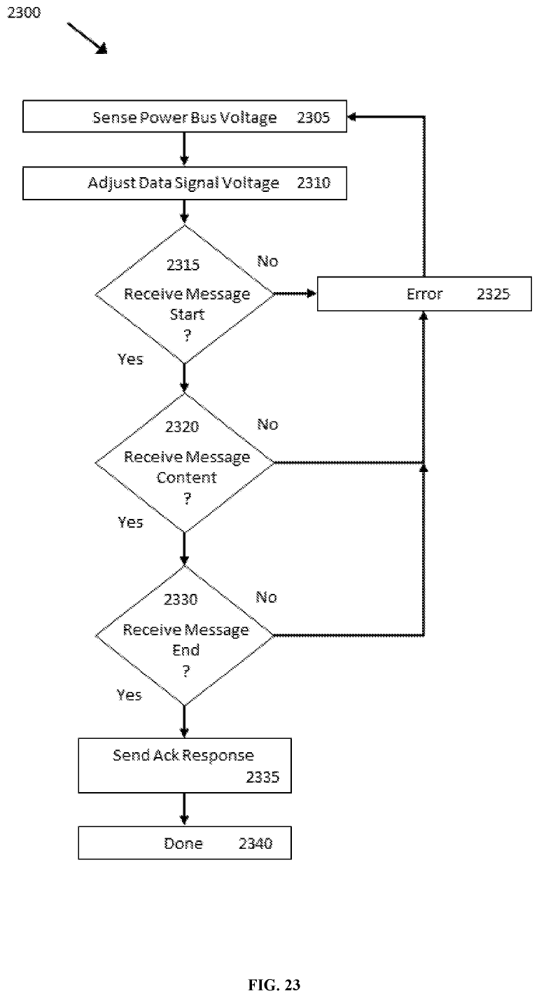

FIG. 23 is a process flow of an exemplary event detecting sensor and alert system power line communication receiver scenario. The process depicted by FIG. 23 is given from the perspective of the CPU (processor) 101 in the exemplary event detecting sensor and alert system 100, both depicted at least in FIG. 1. The depicted process 2300 begins at step 2305 with the processor 101 sensing the power bus voltage and adjusting at step 2310 the data signal voltage superimposed on the power bus. Adjusting the data signal voltage may be implemented with a training or learning sequence including applying a test voltage and measuring the result. At step 2315 the processor 101 performs a test to determine if a message start sequence, as described with reference to FIG. 14, is received within a predetermined period of time. If no message start sequence was received, the process continues at step 2305. If the message start sequence was received, the processor 101 performs a test to determine if message content is received. If no message content was received, the process continues at step 2305. At step 2330 the processor 101 performs a test to determine if a message end sequence is received. If no message end sequence was received, the process continues at step 2305. If the message end sequence was received, the processor 101 sends a response acknowledgement message, as described with reference to FIG. 22.

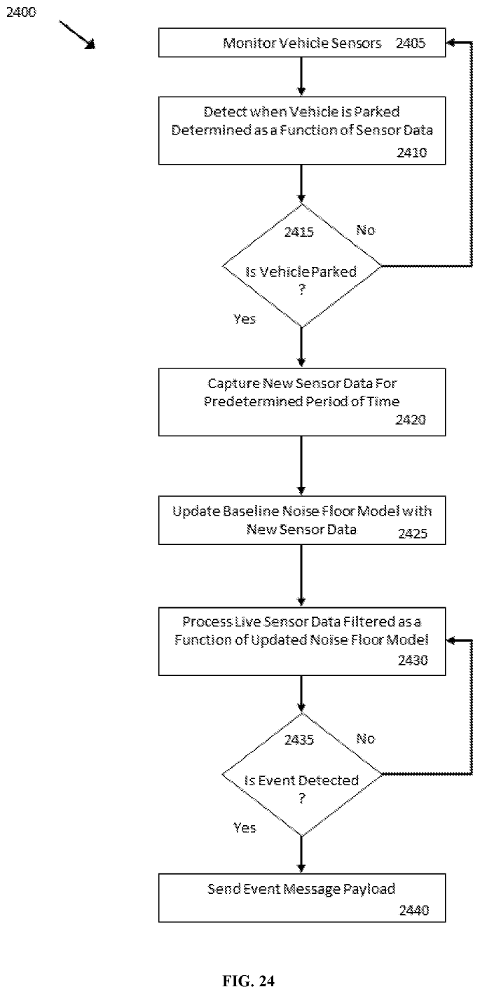

FIG. 24 is a process flow of an exemplary event detecting sensor and alert system baseline noise floor event detection scenario. The process depicted by FIG. 24 is given from the perspective of the CPU (processor) 101 in the exemplary event detecting sensor and alert system 100, both depicted at least in FIG. 1. The depicted process 2400 begins at step 2405 with the processor 101 monitoring data captured by vehicle sensors. Data captured by one or more sensor of various types may be monitored. The one or more sensor may include an accelerometer. At step 2410 the processor 101 detects when the vehicle is parked, determined as a function of sensor data. For example, the processor 101 may monitor accelerometer data to calculate when the vehicle is parked, based on comparing live accelerometer sensor data to a predetermined threshold. At step 2415, the processor 101 performs a test to determine if the vehicle is parked, based on the determination performed by the processor 101 at step 2410. Upon a determination by the processor 101 at step 2415 the vehicle is parked, at step 2420 the processor 101 captures new sensor data for a predetermined period of time, otherwise, the process continues at step 2405. At step 2425 the processor 101 updates a baseline noise floor model with the new sensor data captured at step 2420, to characterize by the updated model the current vehicle environment noise floor based on incorporating the new sensor data into the baseline model. The baseline noise floor model may be received from an original equipment manufacturer, a research organization, another vehicle, or the baseline model may be custom built by the vehicle over time, starting from an initialized state. At step 2430 the processor 101 processes live sensor data filtered as a function of the noise floor model updated by the processor 101 at step 2425. Based on the updated model, the processor 101 may adapt detection sensitivity for triggering on various event types and severities, for example. At step 2435, the processor 101 performs a test to determine if an event is detected, determined as a function of the updated noise floor model and the live sensor data processed by the processor at step 2430. If an event is detected by the processor 101 at step 2435, the process continues at step 2440 with the processor 101 sending an event message payload, otherwise the process continues at step 2430 with the processor 101 processing live sensor data filtered as a function of the updated noise floor model.

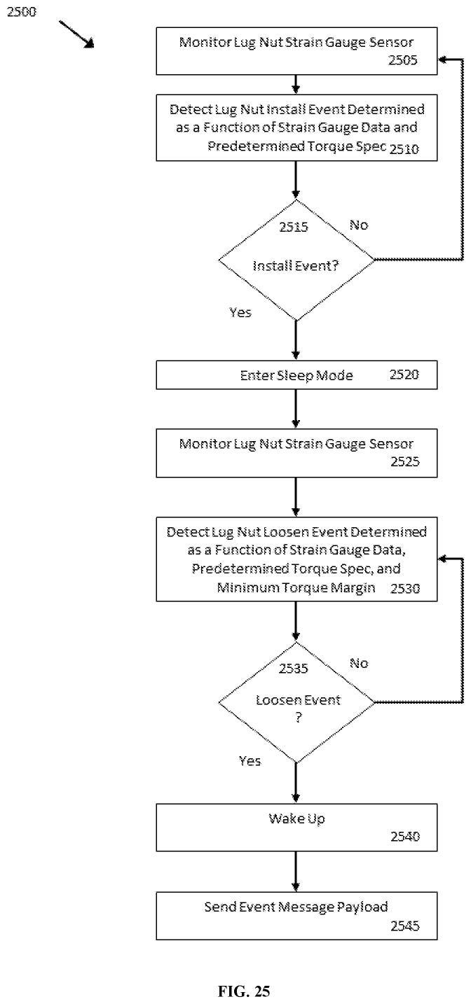

FIG. 25 is a process flow of an exemplary event detecting sensor and alert system lug nut torque event detection scenario. The process depicted by FIG. 25 is given from the perspective of the CPU (processor) 101 in the exemplary event detecting sensor and alert system 100, both depicted at least in FIG. 1. The depicted process 2500 begins at step 2505 with the processor 101 monitoring strain gauge data captured from a strain gauge configured in a lug nut. At step 2510 the process continues with the processor 101 detecting if a lug nut install event, determined as a comparison function of the strain gauge data and a predetermined torque spec, has occurred. At step 2515 the processor 101 performs a test to determine if a lug nut install event occurred, based on the calculation by the processor 101 at step 2510. If a lug nut install event occurred, the process continues at step 2520 with the processor 101 activating sleep, or low power, mode in the event detecting sensor and alert system 100 configured in the lug nut. Otherwise, the process continues at step 2505. In low power or sleep mode at step 2525, the processor monitors the lug nut strain gauge sensor data. At step 2530, the processor 101 detects if a lug nut loosen event determined as a function of strain gauge data, a predetermined torque spec, and a predetermined minimum torque margin, has occurred, based on the monitored strain gauge data. At step 2535 the processor 101 performs a test to determine if a lug nut loosen event occurred, based on the calculation performed by the processor 101 at step 2535. If a lug nut loosen event did not occur, the process continues at step 2530. If a lug nut loosen event did occur, the process continues at step 2540 with the processor 101 configuring the event detecting sensor and alert system 100 to wake up from sleep or low power mode, and send an event message payload at step 2545. Similar embodiments may advantageously improve vehicle and driver safety as a result of notifying vehicle operators that one or more lug nut from an installed wheel has loosened. Various embodiment implementations may reduce the chance of vehicle wheel theft as a result of notifying a vehicle operator that one or more lug nut is being removed without authorization.

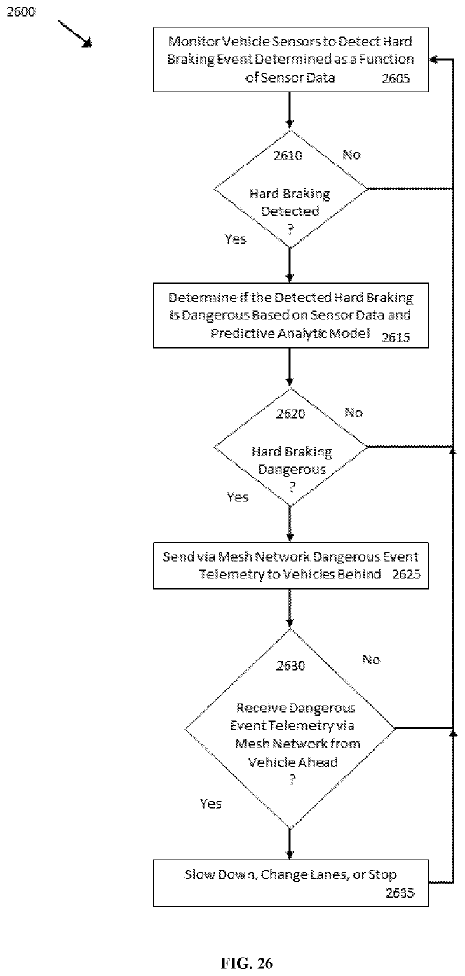

FIG. 26 is a process flow of an exemplary event detecting sensor and alert system multi-vehicle mesh network event detection scenario. The process depicted by FIG. 26 is given from the perspective of the CPU (processor) 101 in the exemplary event detecting sensor and alert system 100, both depicted at least in FIG. 1. The depicted process 2600 begins at step 2605 with the processor 101 monitoring vehicle sensors to detect a hard braking event determined as a function of sensor data. The sensor may be an accelerometer. The depicted example describes a hard braking event, however other safety-related events may be detected. At step 2610 the processor 101 performs a test to determine if hard braking was detected, based on the calculations performed by the processor 101 at step 2605. If no hard braking was detected, the process continues at step 2605. If hard braking was detected, the process continues at step 2615 with the processor 101 determining if the hard braking is dangerous, based on the sensor data processed as a function of a predictive analytic model configured to categorize traffic scenario outcomes based on historical outcomes and historical sensor data. The predictive analytic model may be, for example, a decision tree configured as a CART (Classification and Regression Tree) model to classify traffic scenario outcomes. If the hard braking is determined not dangerous, the process continues at step 2605. If the hard braking is determined dangerous, the process continues at step 2625 with the processor 101 sending via a mesh network to one or more following vehicle telemetry characterizing the dangerous hard braking event. The one or more vehicle receiving the telemetry characterizing the hard braking ahead may slow down, change lanes, or stop, to avoid an incident. The mesh network may be a sub-gigahertz mesh network capable of low latency V2V (Vehicle to Vehicle) communication over distances up to several miles, providing substantial reaction time to following vehicles even at highway speed. At step 2630 the processor 101 performs a test to determine if dangerous event telemetry has been received via the mesh network from a vehicle ahead. If no dangerous event telemetry has been received, the process continues at step 2605. If dangerous event telemetry has been received via the mesh network from a vehicle ahead, the process continues at step 2635 with the processor 101 directing the vehicle to slow down, change lanes, or stop to avoid an incident, and the process continues at step 2605.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

In the present disclosure, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In various embodiments, elements described herein as coupled or connected may have an effectual relationship realizable by a direct connection or indirectly with one or more other intervening elements.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of embodiments of the invention, even those disclosed solely in combination with other features of embodiments of the invention, may be combined in any configuration excepting those readily apparent to the person skilled in the art as nonsensical. Likewise, use of the singular and plural is solely for the sake of illustration and is not to be interpreted as limiting.

In the present disclosure, all embodiments where “comprising” is used may have as alternatives “consisting essentially of,” or “consisting of.” In the present disclosure, any method or apparatus embodiment may be devoid of one or more process steps or components. In the present disclosure, embodiments employing negative limitations are expressly disclosed and considered a part of this disclosure.

The phrases “connected to,” “coupled to” and “in communication with” refer to any form of interaction between two or more entities, including mechanical, electrical, magnetic, electromagnetic, fluid, and thermal interaction. Two components may be functionally coupled to each other even though they are not in direct contact with each other. The term “abutting” refers to items that are in direct physical contact with each other, although the items may not necessarily be attached together.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, Figure, or description thereof for the purpose of streamlining the disclosure. This method of disclosure, however, is not to be interpreted as reflecting an intention that any claim in this or any application claiming priority to this application require more features than those expressly recited in that claim. Rather, as the following claims reflect, inventive aspects may lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

What is claimed is:

1. An event detecting sensor and alert apparatus, comprising:
a power bus;
one or more processor, operably connected to the power bus to receive from the power bus electrical power and a sensor data signal;
one or more sensor, operably connected to the power bus to receive from the power bus electrical power and send a data signal through the power bus; and,
a memory, operably coupled with the one or more processor, the memory encoding data and processor executable program instructions, that when executed by the one or more processor, cause the one or more processor to perform operations comprising:
receive from the power bus a data signal sent by the sensor through the power bus;
detect the occurrence of an event determined as a function of the received data signal; and,
send to a remote processing system an event message payload generated as a function of the detected event.

2. The apparatus of claim 1, wherein the one or more sensor further comprises an accelerometer.

3. The apparatus of claim 1, wherein the one or more sensor further comprises a capacitive touch sensor.

4. The apparatus of claim 1, wherein the data signal sent through the power bus further comprises a message start phase, a message content phase, and a message end phase.

5. The apparatus of claim 4, wherein the capacitive touch sensor is operably connected to the power bus to receive electrical power and send the sensor data signal through the power bus, and wherein the data signal sent through the power bus further comprises a signal voltage superimposed with the power bus supply voltage.

6. The apparatus of claim 4, wherein the operations performed by the one or more processor further comprise determining a valid message has been received through the power bus when the message start phase, the message content phase, and the message end phase have been received without error by the processor.

7. The apparatus of claim 1, wherein the apparatus further comprises a right angle adapter configured to connect a vehicle diagnostic port to a printed circuit board operably retaining an accelerometer, wherein the printed circuit board includes a connector operably coupled with the right angle adapter, and wherein the printed circuit board is not in physical contact with the diagnostic port.

8. The apparatus of claim 7, wherein the apparatus further comprises printed circuit board connector pins formed in a right angle, with the longitudinal dimension of the connector pins joined to the circuit board disposed substantially perpendicular to the plane of the main printed circuit board major surface.

9. The apparatus of claim 7, wherein the apparatus is installed in a vehicle diagnostic port, wherein the plane of the event detecting sensor and alert system main printed circuit board major surface is disposed substantially perpendicular to a plane tangential to each vehicle wheel at the point on each wheel at which, if the vehicle were resting on the vehicle's wheels on a flat surface, that point on each wheel would contact the flat surface on which the vehicle could rest.

10. The apparatus of claim 7, wherein the apparatus further comprises the center of the integrated circuit retaining the accelerometer disposed at least one centimeter from the printed circuit board connector pins closest to the right angle adapter.

11. An event detecting sensor and alert apparatus, comprising:
one or more processor;
one or more sensor, operably connected to the one or more processor;
and, a memory, operably coupled with the one or more processor, the memory encoding data and processor executable program instructions, that when executed by the one or more processor, cause the one or more processor to perform operations comprising:
determine when the vehicle has been parked, based on data from the one or more sensor;
in response to determining the vehicle has been parked, receive new sensor data from the one or more sensor for a predetermined period of time;
update a baseline environmental noise floor model by adding the new baseline sensor data to the model, to determine the new baseline environmental noise floor modeled at the location and time the vehicle was parked;
detect the occurrence of an event determined as a function of live sensor data filtered as a function of the updated baseline environmental noise floor model; and,
send to a remote processing system an event message payload generated as a function of the detected event.

12. The apparatus of claim 11, wherein the one or more sensor further comprises an accelerometer.

13. The apparatus of claim 11, wherein the one or more sensor further comprises a barometric pressure sensor.

14. The apparatus of claim 11, wherein the apparatus further comprises a wireless mesh network interface operably connected to the one or more processor to govern communication with each vehicle of a plurality of other vehicles, and the operations performed by the one or more processor further comprise sending the updated baseline environmental noise floor model to another vehicle of the plurality of other vehicles.

15. The apparatus of claim 11, wherein the apparatus further comprises a wireless mesh network interface operably connected to the one or more processor to govern communication with each vehicle of a plurality of other vehicles, and the operations performed by the one or more processor further comprise: receiving a baseline environmental noise floor model from each vehicle of the plurality of other vehicles; creating a macro environmental noise floor model based on fusing each of the baseline environmental noise floor models received from each vehicle of the plurality of other vehicles; and, providing macro environmental noise floor model access to a decision maker, to generate predictive analytic output based on live sensor data captured by the plurality of vehicles.

16. The apparatus of claim 15, wherein the decision maker is selected from the group consisting of geology research organization, and weather research organization.

17. An event detecting sensor and alert apparatus in each vehicle of a plurality of vehicles, the apparatus comprising:
one or more processor;
one or more accelerometer, operably connected to the one or more processor;
a wireless mesh network interface operably connected to the one or more processor to govern communication with each other vehicle of the plurality of vehicles;
and, a memory, operably coupled with the one or more processor, the memory encoding data and processor executable program instructions, that when executed by the one or more processor, cause the one or more processor to perform operations comprising:
receive sensor data from the accelerometer;
detect the occurrence of an event determined as a function of the sensor data; and,
send to another vehicle of the plurality of vehicles an event message payload generated as a function of the detected event.

18. The apparatus of claim 17, wherein the wireless mesh network further comprises a multi-accessory sub-gigahertz wireless mesh network.

19. The apparatus of claim 17, wherein the operations performed by the one or more processor further comprise:
detect for one vehicle a hard braking event determined as a function of sensor data from the accelerometer located in the hard braking vehicle;
in response to detecting the hard braking event by the braking vehicle, send, by the braking vehicle to another vehicle of the plurality of vehicles driving behind the braking vehicle telemetry indicating hard braking by a vehicle ahead;
receive, by the another vehicle of the plurality of vehicles driving behind the braking vehicle, the telemetry; and,
in response to the telemetry received by the another vehicle of the plurality of vehicles driving behind the braking vehicle, slow down the vehicle driving behind the braking vehicle.

20. The apparatus of claim 17, wherein the apparatus further comprises machine learning and artificial intelligence trained to recognize normal and anomalous traffic patterns determined as functions of historical sensor data characterizing traffic scenario outcomes identified based on mathematical and statistical models, and the operations performed by the one or more processor further comprise:
determining if a traffic pattern determined for at least one vehicle is statistically consistent with normal traffic; and,
in response to determining the traffic pattern is not consistent with normal traffic, sending telemetry to other vehicles behind the at least one vehicle, wherein the telemetry indicates the other vehicles should increase following distance.
